(19) United States
(12) Patent Application Publication
(10) Pub. No.: US 2013/0318077 A1
(43) Pub. Date: Nov. 28, 2013

(54) TARGETED CONTENT DELIVERY BASED ON ZONAL TAXONOMY

(71) Applicants: Michael Froimowitz Greenzeiger, Santa Clara, CA (US); Mehul K. Sanghavi, Sunnyvale, CA (US)

(72) Inventors: Michael Froimowitz Greenzeiger, Santa Clara, CA (US); Mehul K. Sanghavi, Sunnyvale, CA (US)

(73) Assignee: Apple Inc., Cupertino, CA (US)

(21) Appl. No.: 13/480,419

(22) Filed: May 24, 2012

(51) Int. Cl. G06F 17/30

(52) U.S. Cl. 707/724; 707/E17.014

(57) ABSTRACT

The effectiveness of targeted content delivery can be directly linked to the number and type of known user characteristics. A way of improving targeted content delivery can be to infer unknown user characteristics from known information. The present technology utilizes the type of and frequency of a user's visits to one or more predefined location zones to infer unknown user characteristics. The type of location zone and the frequency of visits to the location zone can be combined with other known user characteristics, such as declared user characteristics, to infer one or more characteristics. Additionally, the user's visits to one or more predefined location zones can be used assign a user to one or more targeted segments and to prioritize the segments assigned to the user. Based on the declared and inferred user characteristics and the segment assignments, targeted content can be selected for delivery to the user.

### BACKGROUND

1. Technical Field

The present disclosure relates to targeted content delivery and, more specifically, to intelligent targeting of invitational content to a user based on zonal taxonomy.

2. Introduction

Targeted content delivery has long been an accepted means of conveying a desired message to an audience. Instead of creating a single message and delivering it to every member of the general public, a content provider would prefer to identify a segment of the population that is likely to have the greatest interest in their message. A key aspect in targeted content delivery is identifying those individuals whose characteristics satisfy the target demographics for a particular item of targeted content. The greater the level of specificity in the target set of demographics the more likely it is that the content provider will receive their desired response. However, highly specific target demographics pose a challenge to targeted content delivery because an individual may not explicitly provide the desired characteristics.

The development of digital content delivery has enabled new techniques for identifying user characteristics. However, there are still significant gaps in the known user characteristics. This often leads to targeted content delivery that is overly simplistic or too broad, thereby resulting in decreased satisfaction for both the content provider and the content receiver.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for targeted content delivery based on zonal taxonomy. A method comprises receiving user characteristic data that includes location information. In some cases, the location information can include a location, which is then mapped to one or more location zones. The location zones can include education, transportation, medical, commercial, residential, entertainment, recreation, or colloquial zones. Additional location zones are also possible. Alternatively, the location information can include one or more location zones, each with an associated frequency count indicating the number of visits by the user to the respective location zone. In some cases, the location information can also include date and/or day part data indicating when the visits occurred. After receiving the user characteristic data, it is combined with user characteristic data stored in the user's profile to infer one or more unknown user characteristic values. The unknown user characteristic values can be any type of user characteristics, such as demographic, behavioral, spatial-temporal, etc. Based on the user characteristic values, including any inferred values, invitational content is selected for the user.

A second method comprises receiving a location associated with a user. Based on the received location, a predefined location zone is identified. Additionally, a location zone profile for the user is obtained. The user profile can include a variety of user characteristics including at least one location zone with an associated frequency count. After identifying a location zone for the received location, the user's location zone profile is updated to reflect the visit to the location zone. The update can include adding a new entry to the location zone profile for the location zone. Furthermore, the frequency information associated with the location zone can be incremented. In some cases, there can be different categories of frequency counts associated with a location zone. The categories can have different requirements such that the frequency count is only updated if the requirements are satisfied. In some embodiments, date and/or day part data can be associated with the location. In this case, the location zone profile can be updated to also include the date and/or day part data.

After the location has been used to identify any possible location zones, the location is purged so that only the identified location zones are maintained in the location zone profile. Finally, at some point, user characteristic data, including a location zone and associated frequency from the location zone profile, is sent to a content delivery system. In some cases, the user characteristic data is sent in conjunction with a request for invitational content.

A third method comprises obtaining user characteristic data, which includes at least one location zone and an associated frequency. The user characteristic data is analyzed to assign the user to a targeted segment. In some cases, the analysis can include inferring one or more user characteristic values. After assigning the user to a targeted segment, the segments assigned to the user are prioritized. The targeted segments can include a variety of segment types including demographic segments and location zone segments. At some point a location zone and associated frequency is received. The received location zone and associated frequency are used to reprioritize the segments assigned to the user.

The use of the location and frequency in the reprioritization can vary. In some embodiments, a location zone segment is assigned a higher ranking when the received location zone is used in the location zone segment and the received frequency is below a specified threshold. In some embodiments, a location zone segment is assigned a higher ranking when the received location zone is used in the location zone segment and the location zone is an infrequently visited location zone. In some embodiments, the segments are reprioritized based on the usefulness scores associated with the location zones used in the segments. Additionally, the cost charged to an invitational content provider can vary. In some embodiments, the cost can be greater for invitational content served in response to a location zone segment that uses an infrequently visited location zone. Finally, invitational content is served based on the reprioritized segments.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary configuration of devices and a network;

FIG. 2 illustrates an exemplary method embodiment for assembling location information based on a location;

FIG. 3 illustrates an exemplary method embodiment for inferring user characteristic values based on a location zone and an associated frequency;

FIG. 4 illustrates an exemplary method embodiment for inferring an age user characteristic value based on a location zone and an associated frequency;

FIG. 5 illustrates an exemplary method embodiment for inferring a home region user characteristic value based on a location zone and an associated frequency;

FIG. 6 illustrates an exemplary method embodiment for assigning a user to a targeted segment;

FIG. 7 illustrates a first exemplary method embodiments for assigning a user to a medical zone segment;

FIG. 8 illustrates a second exemplary method embodiment for assigning a user to a medical zone segment;

FIG. 9 illustrates a first exemplary method embodiment for assigning a user to a university zone segment;

FIG. 10 illustrates a second exemplary method embodiment for assigning a user to a university zone segment;

FIG. 11 illustrates an exemplary method embodiment for assigning a user to an entertainment segment;

FIG. 12 illustrates an exemplary method embodiment for assigning a user to a segment based on an inferred user characteristic value.

FIG. 13 illustrates an exemplary method embodiment for prioritizing segments assigned to a user; and

FIG. 14 illustrates an example system embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

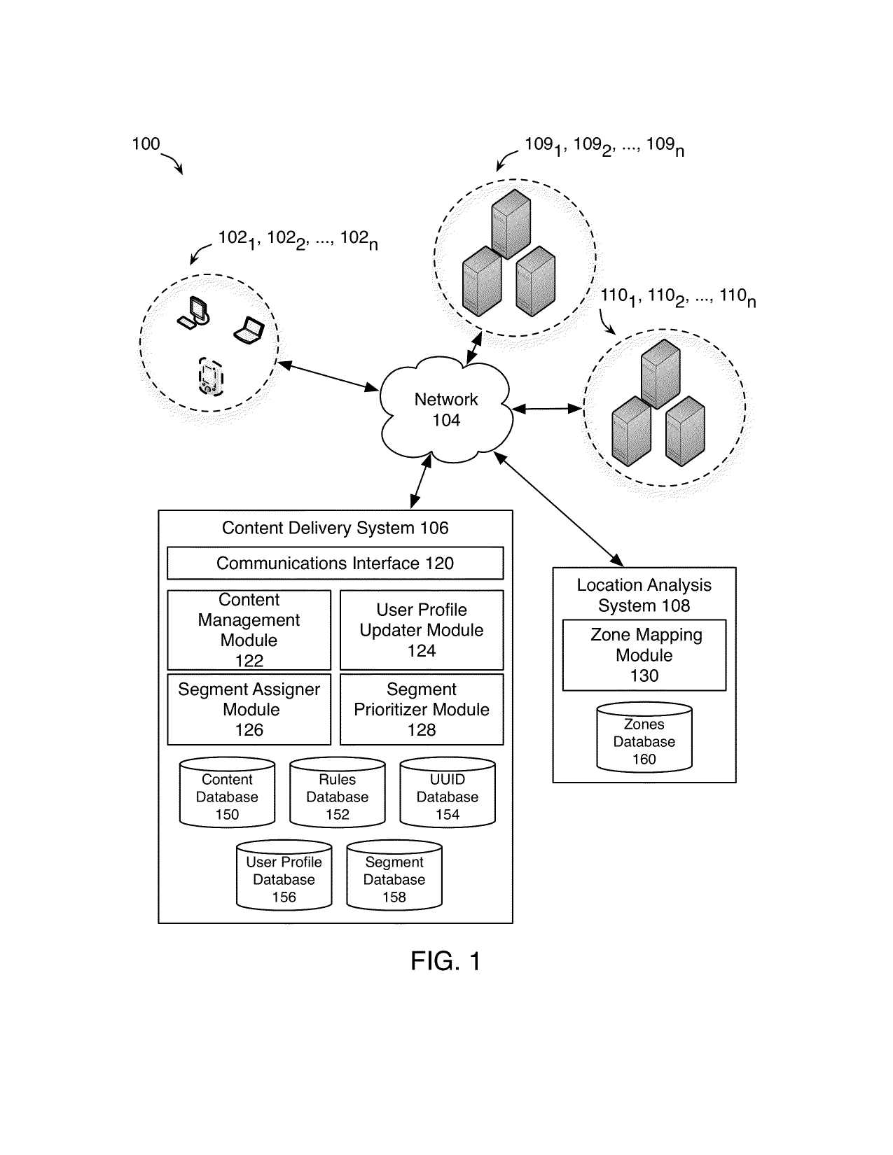

The present disclosure addresses the need in the art for improved targeted content delivery. Using the present technology it is possible to create more refined population segments by utilizing information related to a user's visits to one or more predefined location zones. An exemplary system configuration 100 is illustrated in FIG. 1 wherein electronic devices communicate via a network for purposes of exchanging content and other data. The system can be configured for use on a local area network such as that illustrated in FIG. 1. However, the present principles are applicable to a wide variety of network configurations that facilitate the intercommunication of electronic devices. For example, each of the components of system 100 in FIG. 1 can be implemented in a localized or distributed fashion in a network.

In system 100, invitational content can be delivered to user terminals 102₁, 102₂, . . . , 102ₙ (collectively “102”) connected to a network 104 by direct and/or indirect communications with a content delivery system 106. The content delivery system 106 can support connections from a variety of different client devices, such as desktop computers; mobile computers; handheld communications devices, e.g. mobile phones, smart phones, tablets; and/or any other network enabled communications devices. Furthermore, content delivery system 106 can concurrently accept connections from and interact with multiple user terminals 102.

The content delivery system 106 can receive a request for electronic content, such as a web page, an application, a media item, etc., from one of user terminals 102. Thereafter, the content delivery system 106 can assemble a content package and transmit the assembled content page to the requesting one of user terminals 102. To facilitate communications with the user terminals 102 and/or any other device or component, the content delivery system 106 can include a communications interface 120.

The content delivery system 106 can include a content management module 122 to facilitate the generation of an assembled content package. Specifically, the content management module 122 can combine content from one or more primary content providers 109₁, 109₂, . . . , 109ₙ (collectively “109”) and content from one or more secondary content providers 110₁, 110₂, . . . 110ₙ (collectively “110”) to generate the assembled content package for the user terminals 102. For example, in the case of a web page being delivered to a requesting one of user terminals 102, the content management module 122 can assemble a content package by requesting the data for the web page from one of the primary content providers 109 maintaining the web page. For the invitational content on the web page provided by the secondary content providers 110, the content management module 122 can request the appropriate data according to the arrangement between the primary and secondary content providers 109 and 110. Additionally, the content management module 122 can create content packages that contain content from a single content provider. That is, a content package can contain only primary content or a content package can contain only secondary content. However, the content package is not limited to the content from content providers 109 and 110. Rather, the content package can include other data generated at the content delivery systems 106. In some embodiments, the content delivery system 106 can preselect the content package before a request is received.

An assembled content package can include text, graphics, audio, video, executable code, or any combination thereof. Further, an assembled content package can include invitational content designed to inform or elicit a pre-defined response from the user. In some embodiments, the invitational content can be associated with a product or can directly or indirectly advertise a product. For example, the assembled content package can include one or more types of advertisements from one or more advertisers.

Additionally, the invitational content can be active invitational content. That is, invitational content that is designed to primarily elicit a pre-defined response from a user. For example, active invitational content can include one or more types of advertisements configured to be clicked upon, solicit information, or be converted by the user into a further action, such as purchase or a download of the advertised item. However, invitational content can also be passive invitational content. That is invitational content that is designed to primarily inform the user, such as a video. In some cases, passive invitational content can include information that can lead or direct users to other invitational content including active invitational content.

Furthermore, the invitational content can be dynamic invitational content. That is invitational content that varies over time or that varies based on user interaction. However, the various embodiments are not limited in this regard and the invitational content can include static invitational content that does not vary over time or with user interaction. In the various embodiments, invitational content in a content package can be static or dynamic and active or passive. A content package can include a combination of various types of invitational content in a single content package.

In some cases, a content package can replace or update invitational content in a content package already delivered to a user terminal. For example, a first content package can include an app that can be installed on the user terminal 102. A subsequent content package can include one or more items of invitational content that can be presented to a user of the user terminal 102 while the user interacts with the app.

Although, primary and secondary providers 109 and 110 are presented herein as separate entities, this is for illustrative purposes only. In some cases, the primary and the secondary content providers 109 and 110 can be the same entity. Thus, a single entity can define and provide both the primary and the secondary content.

The content management module 122 can be configured to request that content be sent directly from content providers 109 and 110. Alternatively, a cached arrangement can also be used to improve performance of the content delivery system 106 and improve overall user experience. That is, the content delivery system 106 can include a content database 150 for locally storing/caching content maintained by content providers 109 and 110. The data in the content database 150 can be refreshed or updated on a regular basis to ensure that the content in the database 150 is up to date at the time of a request from a user terminal 102. However, in some cases, the content management module 122 can be configured to retrieve content directly from content providers 109 and 110 if the metadata associated with the data in the content database 150 appears to be outdated or corrupted.

As described above, content maintained by the content providers 109 and 110 can be combined according to a predefined arrangement between the two content providers, which can be embodied as a set of rules. In an arrangement where the content delivery system 106 assembles the content package from multiple content providers, these rules can be stored in a rules database 152 in the content delivery system 106. The content management module 122 can be configured to assemble the content package for user terminals 102 based on these rules. The rules can specify how to select content from secondary content providers 110 and primary content providers 109 in response to a request from one of user terminals 102. For example, in the case of a web page maintained by one of primary content providers 109 and including variable advertisement portions, the rules database 152 can specify rules for selecting one of the secondary providers 110. The rules can also specify how to select specific content from the selected one of secondary providers 110 to be combined with the content provided by one of primary providers 109. Once assembled, the assembled content package can be sent to a requesting one of user terminals 102.

In some content delivery systems an item of primary content, such as an app or other media object, can have one or more associated attributes. For example, an app can have one or more associated genre attributes, e.g. travel, sports, education, etc. A rule can be based on the primary content attributes. An exemplary rule can specify that the content delivery system 106 should select secondary content based on the primary content attributes. For example, the content delivery system 106 can select travel related secondary content, such as an advertisement for an airline, when the primary content has a travel attribute such as a travel related app.

In many cases, a rule based on primary content attributes is a typical arrangement entered into by secondary content providers 110. Such an arrangement can result in invitational content of little or no interest being presented to users. For example, a user that is engaged with a travel related app does not necessarily have a travel intent and thus the user is not necessarily interested in receiving invitational content from an airline. As a result, even though a desired number of impressions can be achieved, the rate of response to such invitational content may be low and/or the resulting targeted audience may be incorrect or suboptimal. Additionally, these simplistic rules can limit the number of secondary content providers that can present invitational content to a user through a single primary content item. For example, a secondary content provider can enter into an arrangement for 100% share of voice (SOV) for a particular attribute or primary content item. Furthermore, if the attribute taxonomy is too general, the secondary content provider may not get the full value because the targeted audience is not well enough constrained.

The various embodiments disclosed herein provide system and methods for intelligently targeting invitational content to a user based on user characteristics. A first aspect of the present technology provides systems and methods for deriving unknown user characteristics based, at least in part, on information related to a user's visits to one or more predefined location zones. A second aspect of the present technology provides systems and methods for assigning a user to one or more targeted segments based, at least in part, on information related to a user's visits to one or more predefined location zones. A third aspect of the present technology provides systems and methods for prioritizing targeted segments associated with a user based on a location zone.

As used herein, the term “user characteristics” refers to the characteristics of a particular user associated with one or more of user terminals 102. User characteristics can include channel characteristics, demographic characteristics, behavioral characteristics, and spatial-temporal characteristics. Channel characteristics can define the specific delivery channel being used to deliver a content package to a user. For example, channel characteristics can include a type of electronic content, a type of device or user terminal, a carrier or network provider, or any other characteristic that defines a specific delivery channel for the content package. Spatial-temporal characteristics can define a location, a location zone, a date, a time, or any other characteristic that defines a geographic location and/or a time for delivery of the content package. Demographic characteristics can define characteristics of the users targeted by the content or associated with the content. For example, demographic characteristics can include age, income, ethnicity, gender, occupation, or any other user characteristics. Behavioral characteristics can define user behaviors for one or more different types of content, separately or in combination with any other user characteristics. That is, different behavioral characteristics may be associated with different channel, demographic, or spatial-temporal characteristics. User characteristics can also include characteristics descriptive of a user's state of mind including characteristics indicative of how likely a user is to click on or convert an item of invitational content if it were displayed to the user. User characteristics can be learned directly or derived indirectly from a variety of sources. In some embodiments, the user characteristic values can be collected from one or more databases. For example, if the user is registered with an online media service, such as the ITUNES store maintained by Apple Inc. of Cupertino, Calif., the collected data could include the user's registration information. Such data can provide values for declared user characteristics. As will become apparent from the remainder of this disclosure, the content delivery system 106 can learn of or derive user characteristics from any number of other information sources.

In some embodiments, the invitational content provided by the secondary content providers 110 can be associated with one or more targeted segments. A targeted segment can be viewed as defining a space or region in k-dimensional space, where each of the k dimensions is associated with one of a plurality of user characteristics. In the various embodiments, the k dimensions can include both orthogonal and non-orthogonal dimensions. That is, some of the k dimensions can overlap or can be related in some aspect. For example, if separate dimensions are specified for city and state, these dimensions are non-orthogonal.

In the various embodiments, the content delivery system 106 can also include a unique user identifier (UUID) database 154 that can be used for managing sessions with the various user terminal devices 102. The UUID database 154 can be used with a variety of session management techniques. For example, the content delivery system 106 can implement an HTTP cookie or any other conventional session management method (e.g., IP address tracking, URL query strings, hidden form fields, window name tracking, authentication methods, and local shared objects) for user terminals 102 connected to content delivery system 106 via a substantially persistent network session. However, other methods can be used as well. For example, in the case of handheld communications devices, e.g. mobile phones, smart phones, tablets, or other types of user terminals connecting using multiple or non-persistent network sessions, multiple requests for content from such devices may be assigned to a same entry in the UUID database 154. The content delivery system 106 can analyze the attributes of requesting devices to determine whether such requests can be attributed to the same device. Such attributes can include device or group-specific attributes.

In some embodiments, the content delivery system 106 can include a user-profile database 156. The user-profile database 156 can, at least in part, be constructed based on declared user characteristics related to one or more users. In some cases, the user-profile database may contain inferred or derived user characteristic values. The user-profile database 156 can be updated using a user-profile-updater module 124. In some embodiments, the user-profile-updater module 124 can be configured to add additional profile data, update profile data, fill in missing profile data, or infer user characteristic values from declared data.

The user-profile-updater module 124 can also be configured to maintain the user profile database 156 to include only more recently acquired data or to re-derive any inferred characteristics in order to ensure that the user profile is an accurate reflection of the current state of the user (location, state of mind, behaviors, demographics, etc. can change rapidly). For example, the user-profile-updater module 124 can be configured to maintain the user profile database 156 to include only data from the last two to three months. However, the user-profile-updater module 124 can be configured to adjust the data in the user profile database 156 to cover any span of time. In some instances the user-profile-updater module 124 can update the profile database 156 in real-time. Alternatively, the user-profile-updater module 124 can be configured to set an expiration period on a subset of the data in the user profile database 156. For example, a policy can specify that user declared data is maintained as long as the user account is active, but user characteristic values based on location information expire after a specified period of time. In some cases, a user can set the expiration period. In some instances, the user-profile-updater module 124 can update the user profile database 156 at least every week, or every day. In some cases, the content delivery system 106 can receive a direct request to update one or more user profiles. The update request can come directly from the user's device or any other device capable of communicating with the content delivery system 106, such as other content delivery networks or websites. In some cases, the content delivery system 106 can receive an indirect request to update one or more user profiles. An indirect request can be the result of receiving new user characteristic values. An update request can occur at any time.

In some embodiments, the content delivery system 106 can include a segment database 158 that is used to aid in selecting invitational content to target to users. The segment database 158 can store defined segments and associations between the segments and users and/or invitational content that should be targeted to users associated with the segments. As described above, a targeted segment can be defined based on one or more user characteristics or derivatives thereof and can be associated with one or more items of invitational content. Additionally, a targeted segment can be associated with one or more users. In some embodiments, by associating a targeted segment with both a user and an item of invitational content, the delivery system can match invitational content with users. In some embodiments, the content delivery system 106 can update the segment database 158 to add newly defined targeted segments or to delete targeted segments.

In some cases a targeted segment can be as simple as a single user characteristic identifier and a single user characteristic value. For example, the common demographic identifiers of gender, age, occupation, or income can each be used in defining corresponding targeted segments. A characteristic value can also be assigned to the identifier. For example, the values of male, 19, and student can be assigned to the user characteristics of gender, age, and occupation, respectively. However, more complex targeted segments can also be defined that consist of one or more identifiers with one or more values associated with each identifier. For example, a targeted segment can be defined to target a user with the following characteristics: gender, male; age, 19-24; location, Northern California or New York City. Additional exemplary segments are described throughout this disclosure. Furthermore, targeted segments can correspond to one or more segments that content providers are likely to easily understand and thus can quickly identify as being relevant to their content. Additionally, in some embodiments, content providers 109 and 110 can define a custom targeted segment.

In some embodiments, the content delivery system 106 can provide a segment assigner module 126. The segment assigner module 126 can apply a set of user characteristics associated with a user (including segments to which a user has been previously assigned) to assign the user to one or more targeted segments. The assigner module 126 can obtain the set of user characteristic values from the user profile database 154 and/or from the user's activities during the current session. The segment assigner module 126 can assign a user to one or more defined targeted segments in the segment database 158, or alternatively, a user can be assigned to a custom targeted segment defined to meet specific goals of a content provider.

Based on the assigned segments, the user profile database 156 can be updated to reflect the segment assignments. Additionally, the content delivery system 106 can use the segment assignments to select targeted content. In some cases, the user profile data in the user profile database 156 can change over time so the segment assigner module 126 can be configured to periodically update the segment assignments in the user profile database 156. The segment assignment update can be triggered at specified intervals, upon detection of a change in the user profile database 156, and/or upon detection of a specified activity in the content delivery system 106.

In some embodiments, the content delivery system 106 can provide a segment-prioritizing module 128 for ordering the targeted segments assigned to a user. The prioritization can be influenced by a number of factors, which can include the user's context, a content provider's campaign goals, and/or the content that is currently available for display to the user. A request to prioritize the targeted segments can be explicit or implicit and can be made by any component of the system 100. For example, a secondary content provider 110 can explicitly request that the content delivery system 106 prioritize the targeted segments or the request can be implicit as part of a request for a content package. The resulting prioritized list can be provided, for example, to the content management module 122, which can then use the information to assemble and deliver a content package. Additionally, the prioritized list can be stored, for example in the user profile, for later use.

The system 100 can also be configured to include a location analysis system 108 that can map a location to one or more predefined location zones. The location analysis system 108 can receive location information associated with a user terminal 102. Whether the location analysis system 108 receives the location information from the content delivery system 106 and/or user terminals 102 can vary with the configuration of the system 100.

The received location information can include a location. The location can be expressed in a variety of different formats, such as latitude and/or longitude, GPS coordinates, city, state, zip code, area code, a predefined point of interest, a landmark, etc. A variety of automated methods for identifying the location of the user terminal 102 are possible, e.g., GPS, triangulation, IP address, etc. Additionally, in some configurations, a user of a client device can enter a location, such as the zip code, city, state, area code, point of interest, and/or landmark, representing the current location of the user terminal 102. Upon receiving a location, the zone mapping module 130 can map the location to one or more predefined location zones. The predefined location zones can be maintained in a location zones database 160. In some cases, the location zones database 160 can be a database of location zone information constructed by a third party. In some cases, the location analysis system 108 can receive a set of locations.

Location zones can be defined in a variety of ways, such as well-established geographic regions, points of interest, points of interest categories, and/or colloquial regions. For example, location zones can be based on well-established geographic regions such as zip code, area code, city, country, etc. In another example, location zones can be based on a point of interest, such as a landmark or a national or state park. In yet another example, location zones can be based on point of interest categories, such as university, transportation, medical, sports stadium, restaurant, shopping, retail, business park, residential, leisure, commercial, entertainment, recreation, school, food and drink, office, beaches, camping, indoor recreation, and/or education. Additional points of interest categories are also possible. In a further example, location zones can be based on colloquial regions, such as The Bay Area, Upstate New York, The Midwest, New England, etc. Furthermore, location zones can have any degree of granularity. That is a location zone can be very general, e.g. transportation zone, or a location zone can be specific, e.g. San Francisco International Airport. However, the granularity can impact the results. For example, a zonal taxonomy that is too general can result in selecting invitational content that is of little or no interest to the user. Alternatively, a zonal taxonomy that is too specific can result in user characteristic values and/or segments that are of little or no interest to the content providers. Additional techniques for defining location zones are also possible. Location zones can also be defined to have different relationships such as overlapping, mutually exclusive, and/or contained. For example, a sports stadium zone can be contained in an entertainment zone or a colloquial region zone such as The Bay Area. In another example, a university zone can overlap with a restaurant zone. In yet another example, a commercial zone can contain retail/shopping, food and drink, and/or office zones. In a further example, a recreation zone can be further divided into indoor and outdoor recreation zones, which can be mutually exclusive. Furthermore, an indoor and/or outdoor recreation zone can contain more specific location zones, such as beach and/or camping zones. In yet a further example, additional zones can be defined to further refine an education zone, such as university, high school, middle school, elementary school, primary education, secondary education, etc.

Although the location analysis system 108 is presented here as a separate entity, this is for illustrative purposes only. In some cases, the content delivery system 106 can include the location analysis system 108. Alternatively, user terminals 102 can each include all or part of a location analysis system 108.

As described above, one aspect of the present technology is the gathering and use of data available from various sources to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, or any other identifying information.

The present disclosure recognizes that the use of such personal information data, in the present technology, can be used to the benefit of users. For example, the personal information data can be used to deliver targeted content that is of greater interest to the user. Accordingly, use of such personal information data enables calculated control of the delivered content. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services. In another example, users can select not to provide location information for targeted content delivery services. In yet another example, users can select to not provide precise location information, but permit the transfer of location zone information.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publically available information.

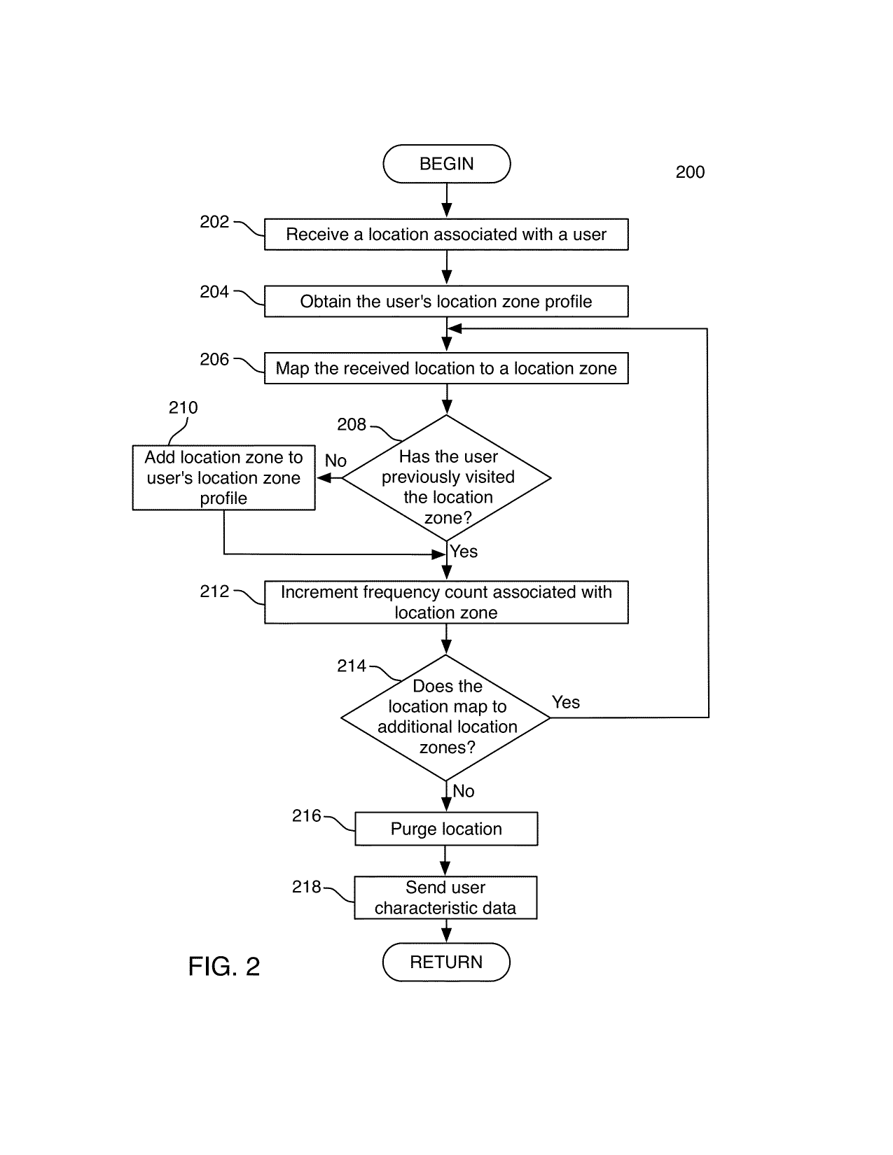

In some embodiments, a user terminal 102 can be configured to assemble location zone information. FIG. 2 is a flowchart illustrating steps in an exemplary method 200 for assembling location zone information based on a location associated with a user. For the sake of clarity, this method is discussed in terms of an exemplary system such as is shown in FIG. 1. Although specific steps are shown in FIG. 2, in other embodiments a method can have more or less steps than show.

The user terminal 102 can receive a location associated with a user (202). The format of the location can vary with the configuration of the user terminal 102 and/or the content delivery system 106, e.g. latitude and/or longitude, GPS, etc. Additionally, in some cases, the user terminal 102 can obtain a date and/or day part to associate with the received location. After receiving the location, the user terminal 102 can obtain the user's location zone profile (204). The location zone profile can include entries for the various location zones the user has visited. Each entry can include a location zone, an associated frequency, a date, and/or a day part. A location zone profile can be stored on the user terminal 102. A user terminal 102 can be configured to only maintain a location zone profile for a specified period of time. For example, the location zone profile can be deleted after sending the location zone information to the content delivery system 106, such as when requesting an item of invitational content. Alternatively, the location zone profile can be deleted at specified intervals, such as 1 week, 1 month, etc.

The user terminal 102 can map the received location to a location zone (206). The mapping can occur by consulting a database of location zone information. In some cases, the database can be contained in the user terminal 102. Alternatively, the database can be an external resource with which the user terminal 102 communicates. After identifying a location zone, the user terminal 102 consults the location zone profile to determine whether an entry exits in the location zone profile for the location zone (208). If the location zone is not in the location zone profile, the user terminal 102 can add a new entry (210). Upon identifying an entry in the location zone profile or after adding a new entry, the user terminal can increment a frequency count associated with the location zone (212). Additionally, if the user terminal 102 obtained a date and/or day part to associate with the location, the user terminal 102 can update the entry in the location zone profile to include the date and/or day part information.

In some configurations, a location zone can have associated criteria that must be satisfied prior to incrementing the frequency count. The associated criteria can be based on a variety of different factors, such as date, day part, length of time in the location zone, etc. For example, a criterion can be that a business location zone is visited during traditional work hours, such as 9 am to 5 pm. In another example, a requirement that a visit to a medical zone is longer than a predefined period of time, such as 30 minutes. Additionally, multiple criterions can be associated such that one or more of the criteria must be satisfied prior to incrementing the frequency count. For example, a requirement that a visit to a business zone occur during traditional working hours, such as 9 am to 5 pm, and during a traditional work week, such as Monday through Friday. Additional frequency criteria are also possible.

Furthermore, in some cases, multiple frequency counts can be associated with a location zone. In this case, each frequency count can be associated with a particular category, such as short visits, longs visits, multiple visits in a single day, visits on a specific date and/or day part, etc. For example, a location zone can have a frequency count for visits less than one hour and visits one hour or longer. In another example, a location zone can have a frequency count for visits on a weekday and visits on a weekend. Additional frequency categories are also possible. The frequency count categories can be defined to be mutually exclusive or overlapping. Additionally, the categories can be defined such that some visits to a location zone are not counted. For example, a location zone can have frequencies categories of 30 minutes to one hour, one hour to eight hours, and eight hours to twenty-four hours. In this example, visits less than 30 minutes would not be counted.

After identifying a location zone, the user terminal 102 determines whether the location maps to an additional location zone (214), which can occur when location zones are overlapping. If additional location zone mappings are possible, the user terminal 102 repeats the mapping process. Once the user terminal 102 has identified all possible location zones for the location, the user terminal 102 can purge the location (216).

At some point the user terminal 102 can send the location zone information to the content delivery system 106 (218). In some cases, the user terminal 102 can send the location zone information in conjunction with a request for an item of invitation content. Furthermore, the user terminal 102 can send the location zone information along with other user characteristic data. In some cases, the user terminal 102 can send only a subset of the location zone information. For example, the user terminal 102 can be configured to send only the location zone entries associated with the user's current location. After sending the user characteristic data, the user terminal 102 resumes previous processing, which can include repeating method 200.

As previously described, in some configurations, location zone information can be assembled at the content delivery system 106 and thus method 200 can also be performed by the content delivery system 106. However, assembling location zone information on a user terminal has the advantage that precise location information is restricted to a user controlled device. Depending on the level of granularity of the location zones, the location zone information can provide a balance between preserving location privacy and delivering content to a user that is likely to be of greater interest.

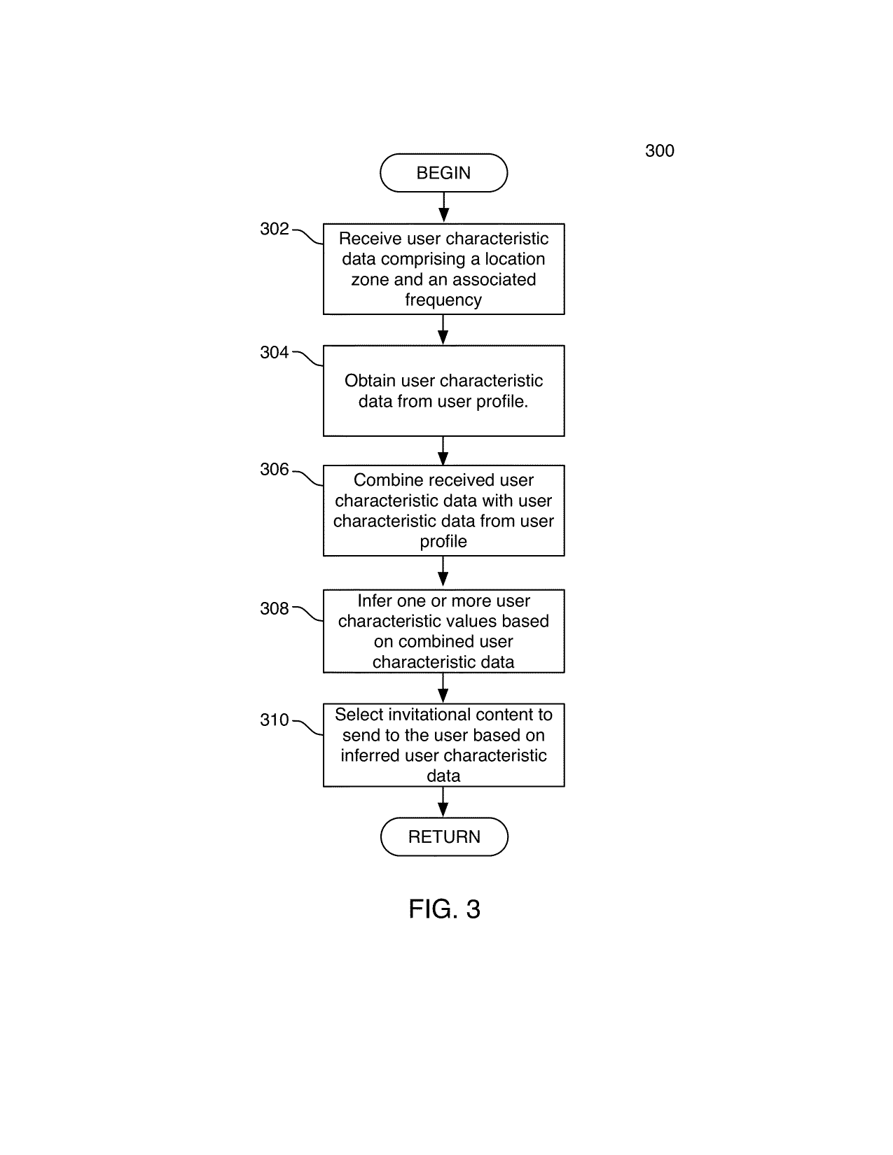

In some embodiments, the content delivery system 106 can be configured to derive unknown user characteristics. FIG. 3 is a flowchart illustrating steps in an exemplary method 300 for inferring unknown user characteristics associated with a user based on at least one location zone and associated frequency data. For the sake of clarity, this method is discussed in terms of an exemplary system such as is shown in FIG. 1. Although specific steps are show in FIG. 3, in other embodiments a method can have more or less steps than shown.

The content delivery system 106 can receive user characteristic data associated with a user (302). The user characteristic data can include at least one location zone and associated frequency information. The frequency information can indicate the number of times that the user visited the location zone. In some cases, the frequency information can include multiple categories of frequency counts, such as short visits, long visits, visits associated with specific dates and/or day parts, etc. Additionally, in some cases, the user characteristic data can include date and/or day part information. The date and day part user characteristic data can be associated with a day and time of day value. The time of day can be values descriptive of a time of day such as dawn, dusk, morning, noon, lunch time, afternoon, commuting hours, etc., or a particular time during the day, e.g. 7 a.m. The date can be a particular day of the week, e.g. Monday; a value descriptive of a part of the week, e.g. workday, weekend; a day of the month, e.g. January 1; or any other value that describes a date. The date and/or day part information can pertain to when the user visited the location zone. Therefore, in some cases, multiple different dates or day parts can be associated with a single location zone for a user.

In some embodiments, the content delivery system 106 can receive the location zone, associated frequency information, and any date and/or day part information from a user terminal 102. This can occur, for example, when the location analysis system 108 resides on the user terminal 102 and/or when the location analysis system 108 is a separate entity, but the user terminal 102 communicates with the location analysis system 108 for the purpose of mapping a location to a location zone. Alternatively, the content delivery system 106 can receive a location from a user terminal 102 and the content delivery system 106 can communicate with the location analysis system 108 to identify a location zone. The content delivery system 106 can receive the location information in conjunction with a request for targeted content and/or through other interaction with the user terminal 102.

After receiving the user characteristic data, the content delivery system 106 can obtain user characteristic data from the user's profile (304). For example, the content delivery system 106 can obtain the data from the user profile database 156. The user characteristic data from the user profile can include a variety of declared and/or inferred user characteristic values. In some cases, the user characteristic data from the user profile can include location zone data, including frequency, date, and/or day part data. The content delivery system 106 can combine the received user characteristic data with the user characteristic data from the user profile (306). In some cases, after combining the data, the content delivery system 106 can update the user profile by storing the combined data in the user profile database 156.

Once the user characteristic data is combined, the content delivery system 106 can infer or derive one or more user characteristic values (308). The inference can be based on any number and/or type of user characteristic values. In some cases, the content delivery system 106 can infer an unknown user characteristic value, such as an unknown demographic value like age or occupation. Alternatively, the content delivery system 106 can update the value of a previously inferred/derived user characteristic value. Additionally, the inference can be based at least in part on the received location zone and the frequency, date, and/or day part data associated with the location zone. For example, the system can infer an age value based on the frequency of visits with a duration of one hour or more to a university zone coupled with the user's income. The inferred user characteristic value can be stored in the user profile.

In some cases, a location zone can have an associated usefulness score to represent the value of the zone within the system. The usefulness score can be derived or assigned depending on the configuration of the system. For example, a usefulness score can be assigned based on the granularity of the zone, e.g. assigning a lower score to more general location zones. In another example, a usefulness score can be derived based on the performance of invitational content served using a location zone. In some cases, a location zone can be assigned a usefulness score and the usefulness score can evolve over time. Additional techniques for assigning and/or deriving a usefulness score are also possible.

A usefulness score can also have an associated range of time. For example, a higher usefulness score can be assigned to a restaurant zone during the time range of 11 am to 11 pm. When a restaurant zone is received outside of the specified time range, the usefulness score can be lower or even zero. In some cases, the lower usefulness score can be explicitly specified. Alternatively, the lower usefulness score can be specified as a score relative to the usefulness score during the time range, e.g. 50%. Alternatively, the time range can specify when the usefulness score drops. For example, a lower usefulness score can be assigned to a university zone during fall, spring, winter, and/or summer break. The time range can be specified in any level of granularity. Some example time ranges can include ranges during an hour or day, specific days of the week, specific weeks or months during the year. For example, a time range associated with a university zone can be specific to the academic calendar. In some cases, the time range can be repeating. For example, 11 am to 11 pm every day or 11 am to 9 pm Sunday through Thursday and 11 am to 1 am Friday and Saturday. Alternatively, the time range can be a single use time range or an expiration date for the usefulness score. For example, a time range associated with a special sporting event that occurs in a different location each time it is held such as the Olympics or the Super Bowl.

In some cases, the usefulness score can be used to implement a form of blacklisting. That is, a usefulness score of zero can be assigned to location zones so that when a user is in the location zone the content delivery system 106 does not deliver targeted content to the user. For example, the system can be configured such that a highway zone is assigned a usefulness score of zero so that targeted content is not delivered to a user while the user is driving. Additionally, the blacklisting can be for a limited time range. For example, a restaurant zone can have an associated usefulness score of zero between 1 and 5 am so that targeted content is not delivered during a time when the restaurants are closed. In another example, a residential zone can have an associated usefulness score of zero during a specified period of time after children get out of school, e.g. 2:30-3:30, so that targeted content is not delivered to children. In some cases, the blacklisting or usefulness score of zero can be automatic, e.g. always happens during a specified period of time or for a specific location. However, the system can also be configured so that the usefulness score is set to zero after occurrence of multiple events. For example, the usefulness score can be set to zero for a residential zone during a specified period of time after children get out of school if an increase in activity is detected, such as increased app usage, web serving, etc.

Additionally, a usefulness score can be associated with a frequency. For example, a location zone can have multiple usefulness scores such that the greater the visit frequency, the higher the usefulness score. Therefore, based on the user's frequency of visits to the location zone, a usefulness score is selected. In some cases, a usefulness score based on frequency of visit can be used to reward a user's loyalty or consistency of visits within a particular location zone.

One use of the usefulness score can be in inferring user characteristic values when a location zone is used as part of the inference technique. For example, the content delivery system 106 can be configured to only use data associated with a location zone that has a usefulness score above a predefined threshold value.

Additionally, as part of the derivation method, the content delivery system 106 can assign a confidence score to the derived value, where the confidence score represents the likelihood that the particular characteristic is valid and/or correct. For example, a characteristic can be assigned a value in the range [0,1], where 0 indicates no confidence and 1 indicates full confidence. Other relative indicators of confidence can also be used, such as a percentage. In some cases, the confidence score associated with a user characteristic for a user can evolve over time. For example, the confidence score can start at 0, and as more information is learned the confidence score can increase.

The calculation of the confidence score can depend on the user characteristic, how the characteristic is obtained, the number of characteristics considered, etc. In some cases, the confidence score can be based at least in part on the usefulness score associated with a location zone used to infer the user characteristic value. Additionally, the confidence score can be based on the location zone itself. For example, the granularity and/or size of the location zone can influence the confidence score, e.g. a larger location zone can result in a higher confidence score. Furthermore, the confidence score can be based at least in part on the frequency category used in the inference. For example, a frequency category that includes any visit to the zone regardless of the duration of the visit, may provide a less reliable inference and thus a lower confidence score can be assigned to the inferred value.

In some cases, the relationship between the usefulness score and the confidence score can be inversely proportional. For example, in a shopping mall, the user may pass through multiple location zones, e.g. retail, restaurant, and/or entertainment. In this case, the confidence score of a particular location zone can be lower, but the usefulness score can be higher. Likewise, if the user is in a university zone, which is often a large zone, the confidence score can be higher, but the usefulness score can be lower. Alternatively, the relationship between the usefulness score and the confidence score can be directly proportional. For example, a user in a transportation zone, such as an airport can have a high usefulness score and a high confidence score.

At some point, the content delivery system 106 can select invitational content to send to the user terminal 102 (310). The selection of the invitational content can be based the user characteristics values. In particular, the selection can be based at least in part on the inferred user characteristic value. In some cases, the selection can be in response to a request for invitational content. Alternatively, the selection can be in response to a request to update the user profile. In this case, the selected invitational content can be stored in the user profile or in some other storage location for later delivery. After selecting the invitational content, the content delivery system 106 resumes previous processing, which can include repeating method 300.

The above-described method of inferring an unknown user characteristic illustrates the concept by using a single inference algorithm to derive a value for a user characteristic. However, in some cases, the content delivery system 106 can include multiple inference algorithms for deriving values for the same user characteristic. In some cases, the values can have associated confidence scores that can be used in determining which inferred value to use. Alternatively, the value selection can be based on a combination of the inferred values, the value that occurs most frequently, or the context, such as the relationship between the current location zone and the location zone used to infer the values.

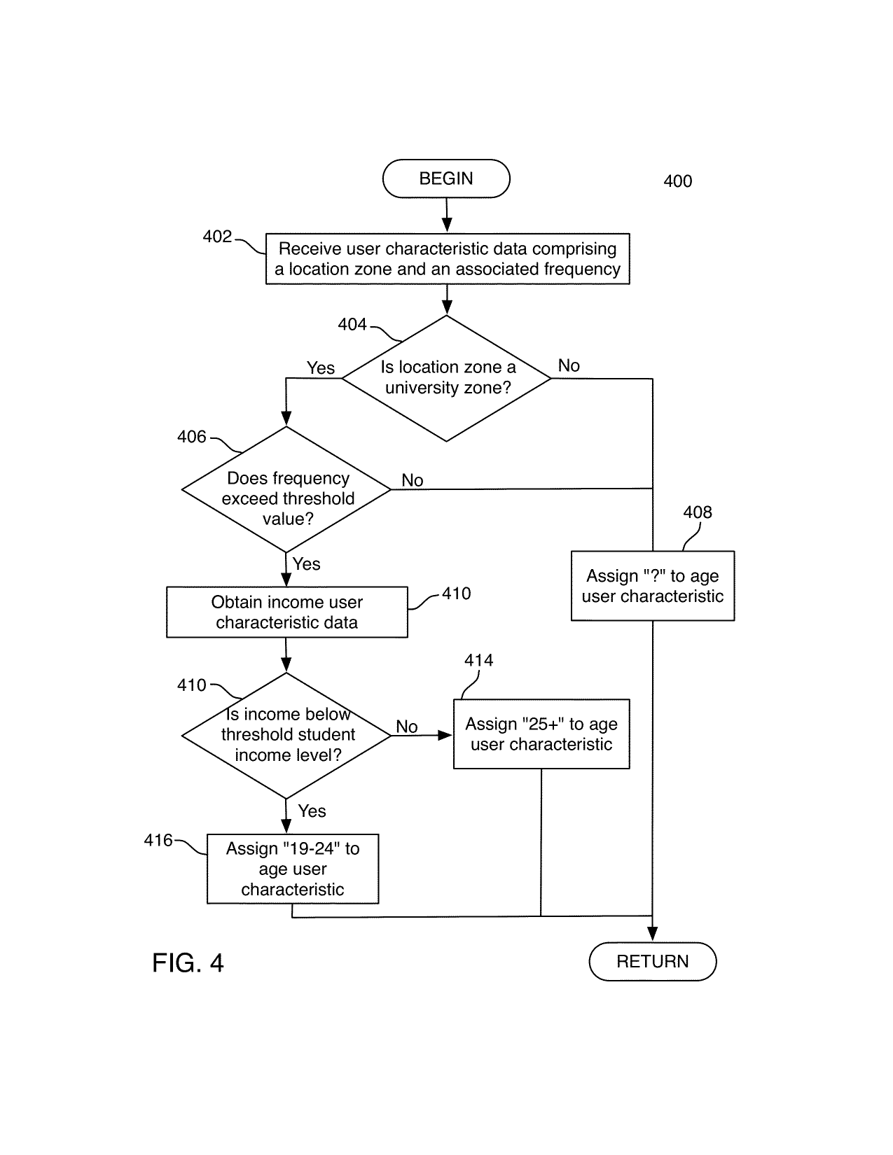

FIG. 4 is a flowchart illustrating steps in an exemplary method 400 for inferring an age user characteristic value. For the sake of clarity, this method is discussed in terms of an exemplary system such as is shown in FIG. 1. Although specific steps are shown in FIG. 4, in other embodiments a method can have more or less steps than show.

The content delivery system 106 can receive user characteristic data associated with a user (402). The user characteristic data can include at least one location zone and associated frequency information. The frequency information can indicate the number of times that the user visited the location zone. In some cases, the frequency information can include different categories of frequencies, such as categories based on duration of the visit. The content delivery system 106 can be configured to use one or more categories of frequencies to refine the inference. For example, the content delivery system 106 can use the frequency category in which the duration of the visit is greater than 1 hour, so as to increase the confidence level associated with the inference. At some point after receiving the user characteristic data, the content delivery system 106 can check if the received location zone is a university zone (404). If the location zone is not a university zone, the content delivery system 106 can assign unknown to the age user characteristic value (408).

If the location zone is a university zone, the content delivery system 106 can check if the frequency associated with the location zone exceeds a threshold value (406). In some cases, the received frequency data can be combined with frequency data for the location zone in the user profile. For example, the user may have previously visited the location zone and sent the frequency data to the content delivery system 106. If the frequency value does not exceed the predefined threshold value, the content delivery system 106 can assign unknown to the age user characteristic value (408).

If the frequency value does exceed the threshold, the content delivery system can obtain the income user characteristic value for the user (410). In some cases, the income user characteristic data can be stored in the user's profile, such as in user profile database 156. Additionally, the income user characteristic value can be included in the received user characteristic data. After obtaining the income value, the content delivery system 106 can check if the income value is below a specified threshold student income level (410).

If the income is below the student threshold value, the content delivery system 106 can assign “19-24” to the age user characteristic (416). Alternatively, the content delivery system 106 can assign “25+” to the age user characteristic (414). In some cases, the content delivery system 106 can assign a confidence score to the inferred/derived value. For example, the confidence score can be based on the frequency value, e.g. the greater the frequency the greater the confidence score. After assigning a value to the age user characteristic, the content delivery system 106 resumes previous processing, which can include repeating method 400.

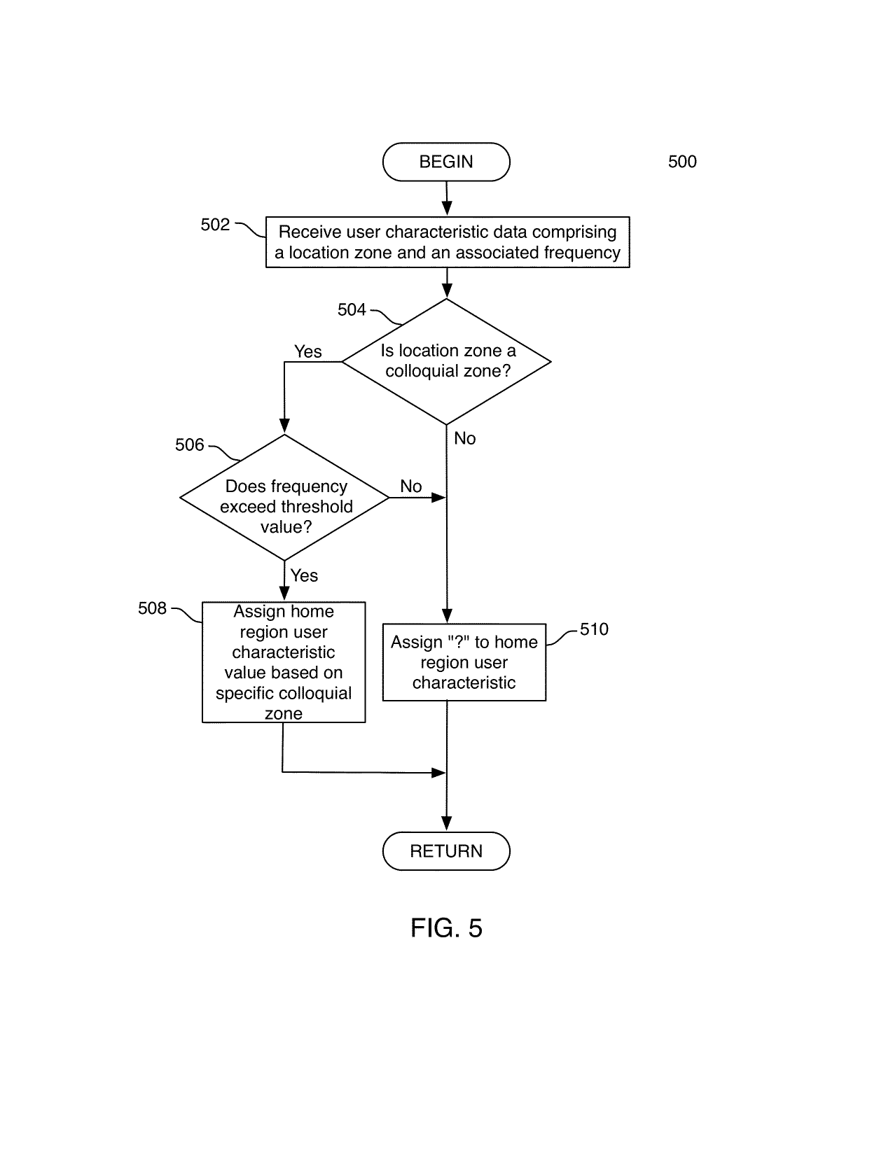

FIG. 5 is a flowchart illustrating steps in an exemplary method 500 for inferring a home region. For the sake of clarity, this method is discussed in terms of an exemplary system such as is shown in FIG. 1. Although specific steps are shown in FIG. 5, in other embodiments a method can have more or less steps than show.

The content delivery system 106 can receive user characteristic data associated with a user (502). The user characteristic data can include at least one location zone and associated frequency information. The frequency information can indicate the number of times that the user visited the location zone. At some point after receiving the user characteristic data, the content delivery system 106 can check if the received location zone is a colloquial zone (504). If the location zone is not a colloquial zone, the content delivery system 106 can assign unknown to the home region user characteristic value (510).

If the location zone is a colloquial zone, the content delivery system 106 can check if the frequency associated with the location zone exceeds a threshold value (506). In some cases, the received frequency data can be combined with frequency data for the location zone in the user profile. For example, the user may have previously visited the location zone and sent the frequency data to the content delivery system 106. If the frequency value does not exceed the predefined threshold value, the content delivery system 106 can assign unknown to the home region user characteristic value (510).

If the frequency value does exceed the threshold, the content delivery system can assign the home region user characteristic based on the specific colloquial zone (508). For example, if the colloquial zone is “The Bay Area,” the content delivery system 106 can assign “The Bay Area” to the home region user characteristic. In some cases, the content delivery system 106 can assign a confidence score to the inferred/derived value. For example, the confidence score can be based on the frequency value, e.g. the greater the frequency the greater the confidence score. After assigning a value to the home region user characteristic, the content delivery system 106 resumes previous processing, which can include repeating method 500.

Methods 400 and 500 in FIGS. 4 and 5 respectively, illustrate just two particular methods of inferring/deriving user characteristic values. Additional methods are also possible. Furthermore, the use of location zones, frequencies, dates, and/or day parts to infer user characteristic values is not limited to inferring demographic values. Additional characteristics are also possible, such as behavioral characteristics, spatial-temporal characteristics, etc. For example, the content delivery system 106 can infer a university status value based on the frequency of visits to a university zone and the user's age and income user characteristic values. In another example, the content delivery system 106 can infer a travel user characteristic value based on the frequency in a transportation zone. In yet another example, the content delivery system 106 can infer a medical professional status user characteristic value based on the frequency in a medical zone and age and income user characteristic values. While methods 400 and 500 illustrate inferring/deriving a single user characteristic value based on a single location zone, it is also possible to infer/derive multiple user characteristics and/or use multiple location zones.

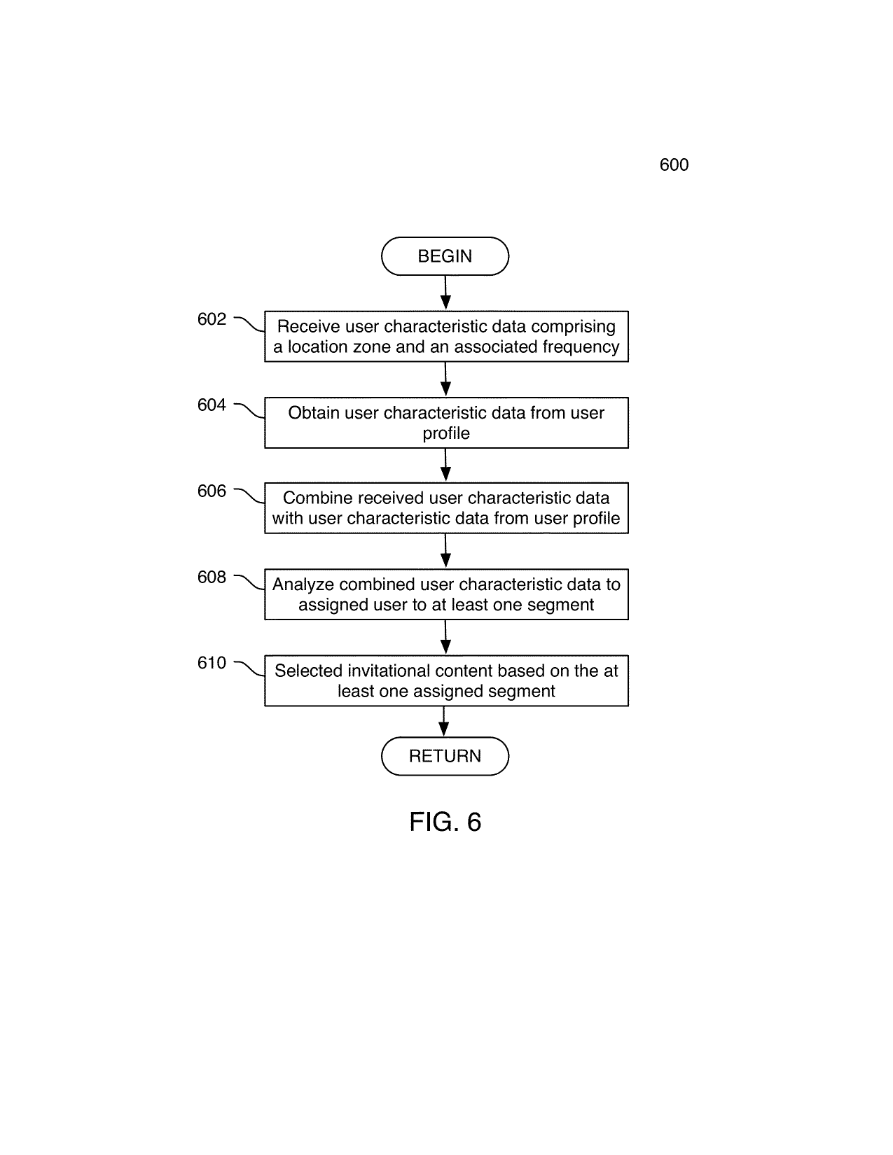

In some embodiments, the content delivery system 106 can be configured to assign a user to one or more targeted segments. FIG. 6 is a flowchart illustrating steps in an exemplary method 600 for assigning a user to one or more targeted segments based at least in part on information related to a user's visits to one or more predefined location zones. For the sake of clarity, this method is discussed in terms of an exemplary system such as is shown in FIG. 1. Although specific steps are show in FIG. 6, in other embodiments a method can have more or less steps than shown.

The content delivery system 106 can receive user characteristic data associated with a user (602). The user characteristic data can include at least one location zone and associated frequency information. The frequency information can indicate the number of times that the user visited the location zone. Additionally, in some cases, the user characteristic data can include date and/or day part information.

In some embodiments, the content delivery system 106 can receive the location zone, associated frequency information, and any date and/or day part information from a user terminal 102. This can occur, for example, when the location analysis system 108 resides on the user terminal 102 and/or when the location analysis system 108 is a separate entity, but the user terminal 102 communicates with the location analysis system 108 for the purpose of mapping a location to a location zone. Alternatively, the content delivery system 106 can receive a location from a user terminal 102 and the content delivery system 106 can communicate with the location analysis system 108 to identify a location zone. The content delivery system 106 can receive the location information in conjunction with a request for targeted content and/or through other interaction with the user terminal 102.

After receiving the user characteristic data, the content delivery system 106 can obtain user characteristic data from the user's profile (604). For example, the content delivery system 106 can obtain the data from the user profile database 156. The user profile user characteristic data can include a variety of declared and/or inferred user characteristic values. In some cases, the user profile user characteristic data can include location zone data, including frequency, date, and/or day part data. The content delivery system 106 can combine the received user characteristic data with the user profile user characteristic data (606). In some cases, after combining the data, the content delivery system 106 can update the user profile by storing the combined data in the user profile database 156.

Once the user characteristic data is combined, the content delivery system 106 can analyze the combined user characteristic data to assign the user to at least one targeted segment (608). The assignment can be based on any number and/or type of user characteristic values. Furthermore, the user characteristic values can be declared and/or derived/inferred. The content delivery system 106 can be configured to support a variety of targeted segment types. For example, a targeted segment can be a demographic segment, a location zone segment, a spatial-temporal segment, a behavioral segment, etc. In some configurations, a demographic segment can be predominately or exclusively composed of demographic user characteristics. Likewise, a location zone segment can be based on a location zone and the associated data, such as frequency, date, and/or day part. The assigned segment can be stored in the user's profile, such as in the user profile database 156.

As previously described, in some cases, a location zone can have an associated usefulness score to represent the value of the zone within the system. A use of the usefulness score can be in assigning a user to a targeted segment. For example, the content delivery system 106 can be configured to only use data associated with a location zone that has a usefulness score above a predefined threshold value.

Additionally, as part of the segment assignment method, the content delivery system 106 can assign a confidence score to the assigned segment, where the confidence score represents the likelihood that the assigned segment is valid and/or correct. For example, a segment can be assigned a value in the range [0,1], where 0 indicates no confidence and 1 indicates full confidence. Other relative indicators of confidence can also be used, such as a percentage. The calculation of the confidence score can depend on the user characteristic values used to assign the user to the targeted segment. For example, if the segment assignment is based on one or more inferred/derived user characteristic values, the confidence score can be lower. In some cases, the confidence score can be based at least in part on the usefulness score associated with a location zone used to assign the user to the targeted segment. For example, a lower usefulness score can lead to a lower confidence score.

At some point, the content delivery system 106 can select invitational content to send to the user terminal 102 based on the segment assignment (610). In some cases, the selection can be in response to a request for invitational content. Alternatively, the selection can be in response to a request to update the user profile. In this case, the selected invitational content can be stored in the user profile or in some other storage location for later delivery. After selecting the invitational content, the content delivery system 106 resumes previous processing, which can include repeating method 600.

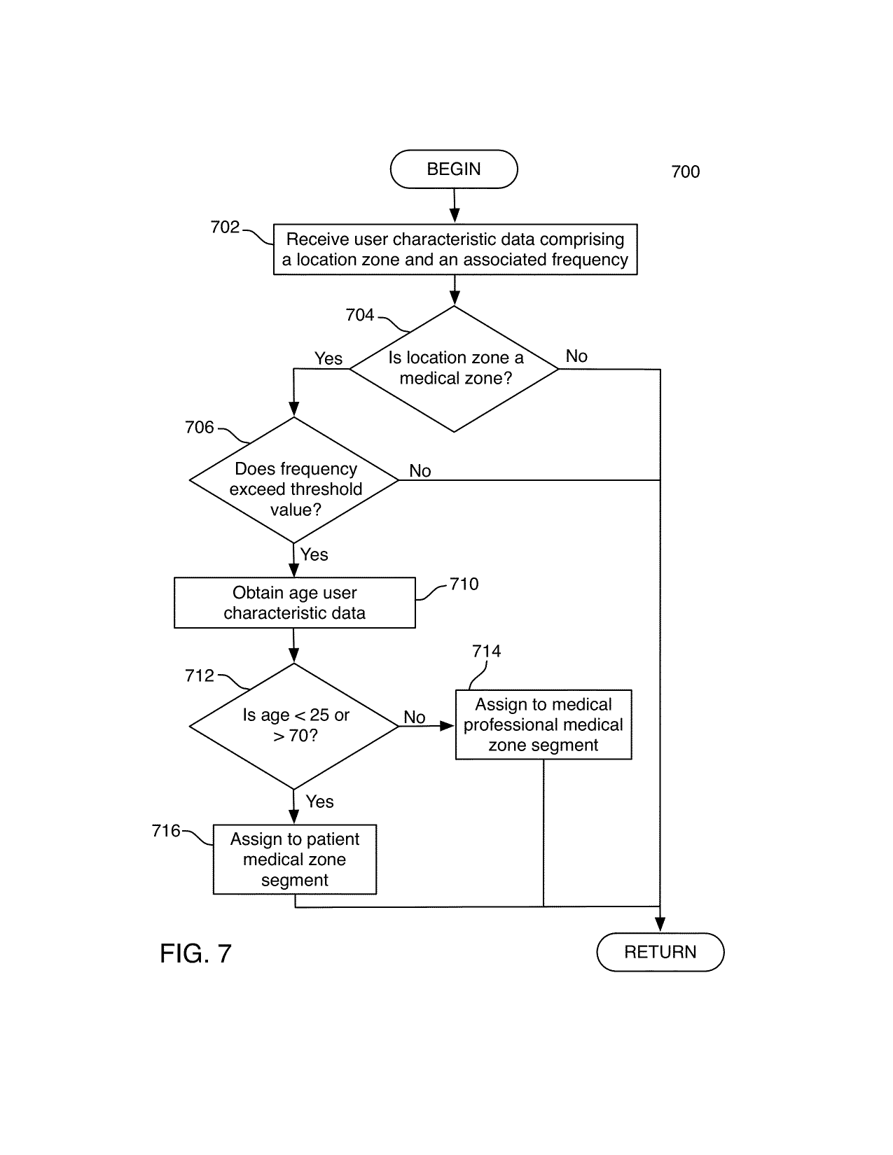

FIG. 7 is a flowchart illustrating steps in an exemplary method 700 for assigning a user to a medical zone segment. For the sake of clarity, this method is discussed in terms of an exemplary system such as is shown in FIG. 1. Although specific steps are shown in FIG. 7, in other embodiments a method can have more or less steps than show.

The content delivery system 106 can receive user characteristic data associated with a user (702). The user characteristic data can include at least one location zone and associated frequency information. The frequency information can indicate the number of times that the user visited the location zone. In some cases, the frequency information can be split into one or more frequency categories. At some point after receiving the user characteristic data, the content delivery system 106 can check if the received location zone is a medical zone (704). If the location zone is not a medical zone, the content delivery system 106 does not assign the user to a medical zone segment and the content delivery system 106 can resume previous processing.

If the location zone is a medical zone, the content delivery system 106 can check if the frequency associated with the location zone exceeds a threshold value (706). In some cases, the received frequency data can be combined with frequency data for the location zone in the user profile. For example, the user may have previously visited the location zone and sent the frequency data to the content delivery system 106. Furthermore, in some cases, the frequency data can be a particular category of frequency data. For example, a frequency count associated with visits with a duration of more than 30 minutes. Categorical frequency data can be used to increase the probability that an inference or assignment is correct. For example, a visit in excess of 30 minutes can be used to exclude users visiting a patient. If the frequency value does not exceed the predefined threshold value, the content delivery system 106 does not assign the user to a medical zone segment and the content delivery system 106 can resume previous processing.

If the frequency value does exceed the threshold, the content delivery system 106 can obtain the age user characteristic value for the user (710). In some cases, the age user characteristic data can be stored in the user's profile, such as in user profile database 156. Additionally, the age user characteristic value can be included in the received user characteristic data. After obtaining the age value, the content delivery system 106 can check if the age value is less than 25 or greater 70 (712). If so, the content delivery system 106 can assign the user to the patient medical zone segment (716). Otherwise, the content delivery system 106 can assign the user to the medical professional medical zone segment (714). After assigning the user to a medical zone segment, the content delivery system 106 resumes previous processing, which can include repeating method 700.

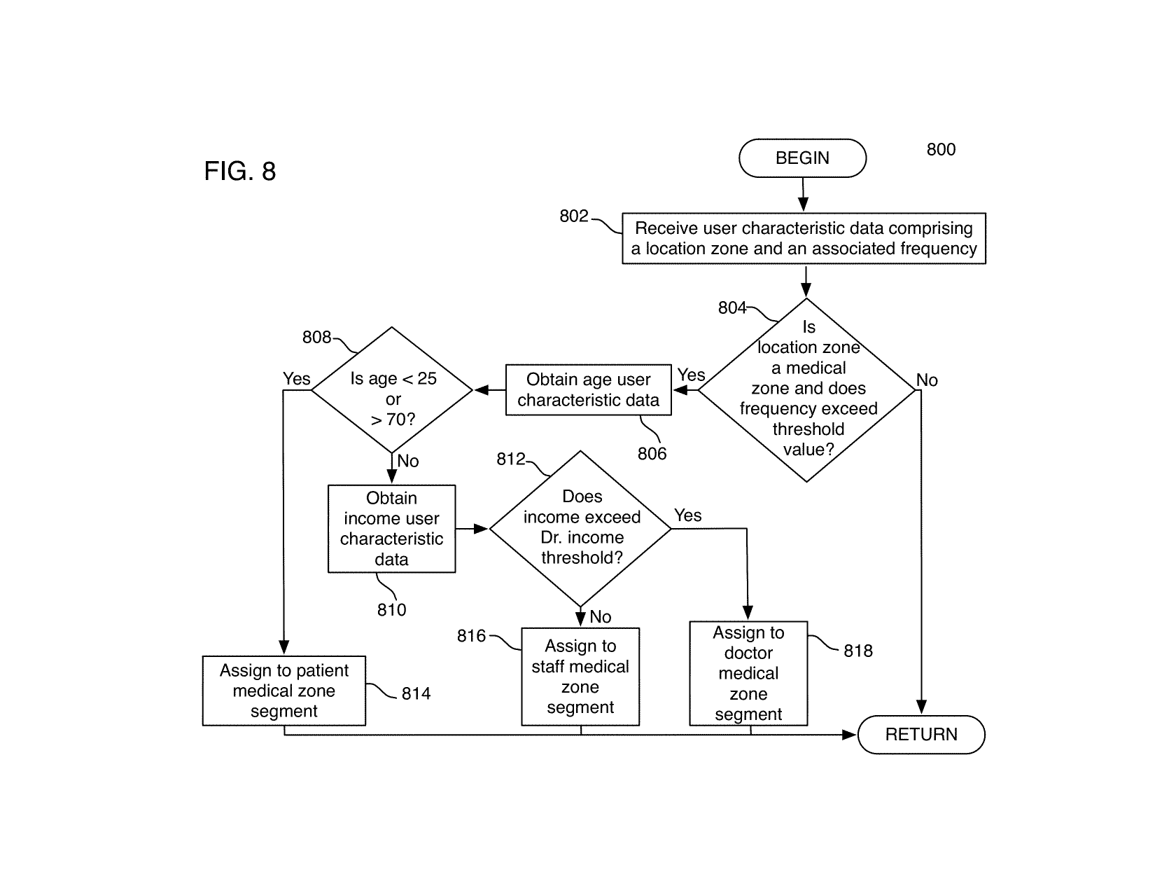

FIG. 8 is a flowchart illustrating steps in a second exemplary method 800 for assigning a user to a medical zone segment. For the sake of clarity, this method is discussed in terms of an exemplary system such as is shown in FIG. 1. Although specific steps are shown in FIG. 8, in other embodiments a method can have more or less steps than show.

The content delivery system 106 can receive user characteristic data associated with a user (802). The user characteristic data can include at least one location zone and associated frequency information. At some point after receiving the user characteristic data, the content delivery system 106 can check if the received location zone is a medical zone and if the frequency associated with the medical zone exceeds a predefined threshold value (804). If the location zone is not a medical zone or the frequency associated with the medical zone does not exceed the threshold, the content delivery system 106 does not assign the user to a medical zone segment and the content delivery system 106 can resume previous processing.

If the location zone is a medical zone and the associated frequency exceeds the threshold, the content delivery system 106 can obtain the age user characteristic value for the user (806). In some cases, the age user characteristic data can be stored in the user's profile, such as in user profile database 156. Additionally, the age user characteristic value can be included in the received user characteristic data. After obtaining the age value, the content delivery system 106 can check if the age value is less than 25 or greater 70 (808). If so, the content delivery system 106 can assign the user to the patient medical zone segment (814).

Otherwise, if the user's age value is 25-70, the content delivery system 106 can obtain the income user characteristic value (810). After obtaining the income value, the content delivery system 106 can check if the income exceeds the predefined threshold income for a doctor (812). If it does, the content delivery system 106 can assign the user to the doctor medical zone segment (818). Otherwise, the content delivery system 106 can assign the user to the staff medical zone segment (816). After assigning the user to a medical zone segment, the content delivery system 106 resumes previous processing, which can include repeating method 800.

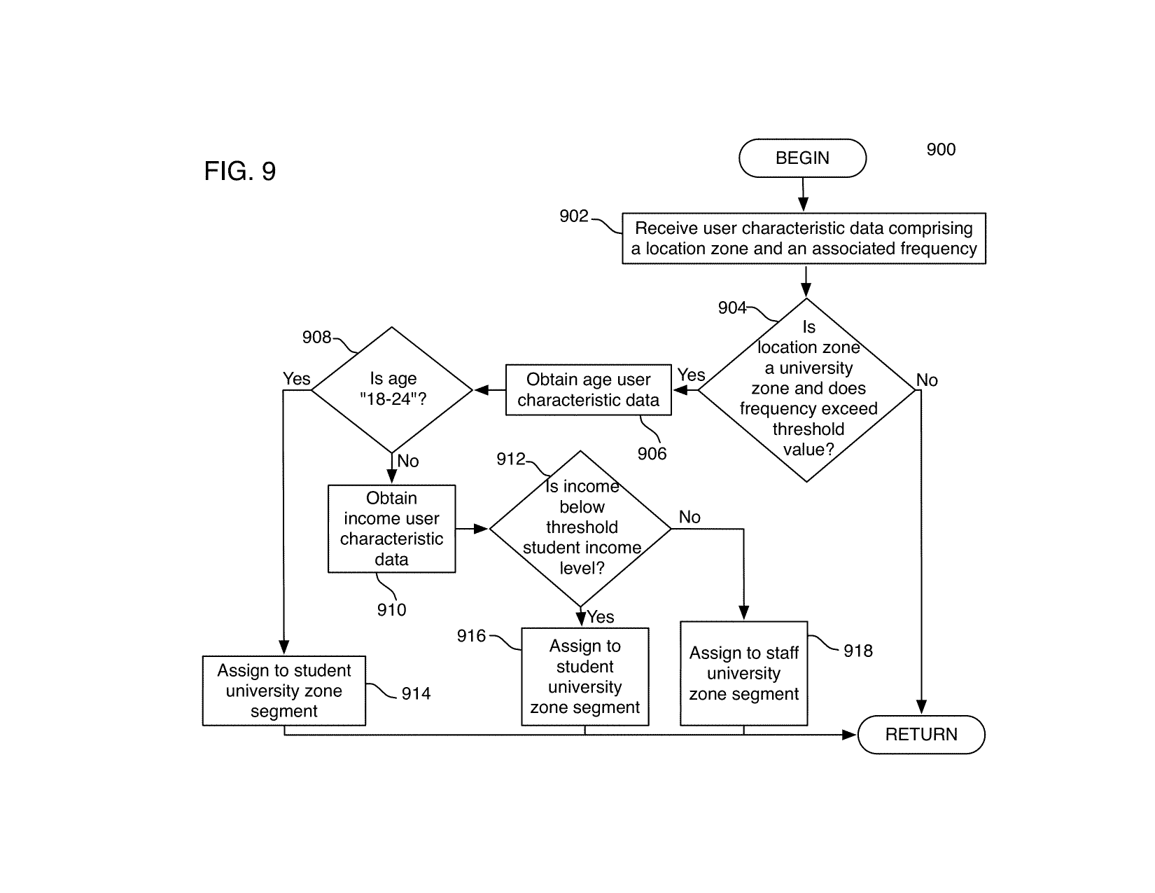

FIG. 9 is a flowchart illustrating steps in an exemplary method 900 for assigning a user to a university zone segment. For the sake of clarity, this method is discussed in terms of an exemplary system such as is shown in FIG. 1. Although specific steps are shown in FIG. 9, in other embodiments a method can have more or less steps than show.

The content delivery system 106 can receive user characteristic data associated with a user (902). The user characteristic data can include at least one location zone and associated frequency information. At some point after receiving the user characteristic data, the content delivery system 106 can check if the received location zone is a university zone and if the frequency associated with the university zone exceeds a predefined threshold value (904). If the location zone is not a university zone or the frequency associated with the university zone does not exceed the threshold, the content delivery system 106 does not assign the user to a university zone segment and the content delivery system 106 can resume previous processing.

If the location zone is a university zone and the associated frequency exceeds the threshold, the content delivery system 106 can obtain the age user characteristic value for the user (906). In some cases, the age user characteristic data can be stored in the user's profile, such as in user profile database 156. Additionally, the age user characteristic value can be included in the received user characteristic data. After obtaining the age value, the content delivery system 106 can check if the age value is “18-24” (908). If so, the content delivery system 106 can assign the user to the student university zone segment (914).

Otherwise, the content delivery system 106 can obtain the income user characteristic value (910). After obtaining the income value, the content delivery system 106 can check if the income is below the threshold student income level (912). If it is, the content delivery system 106 can assign the user to the student university zone segment (916). Otherwise, the content delivery system 106 can assign the user to the staff university zone segment (918). After assigning the user to a university zone segment, the content delivery system 106 resumes previous processing, which can include repeating method 900.

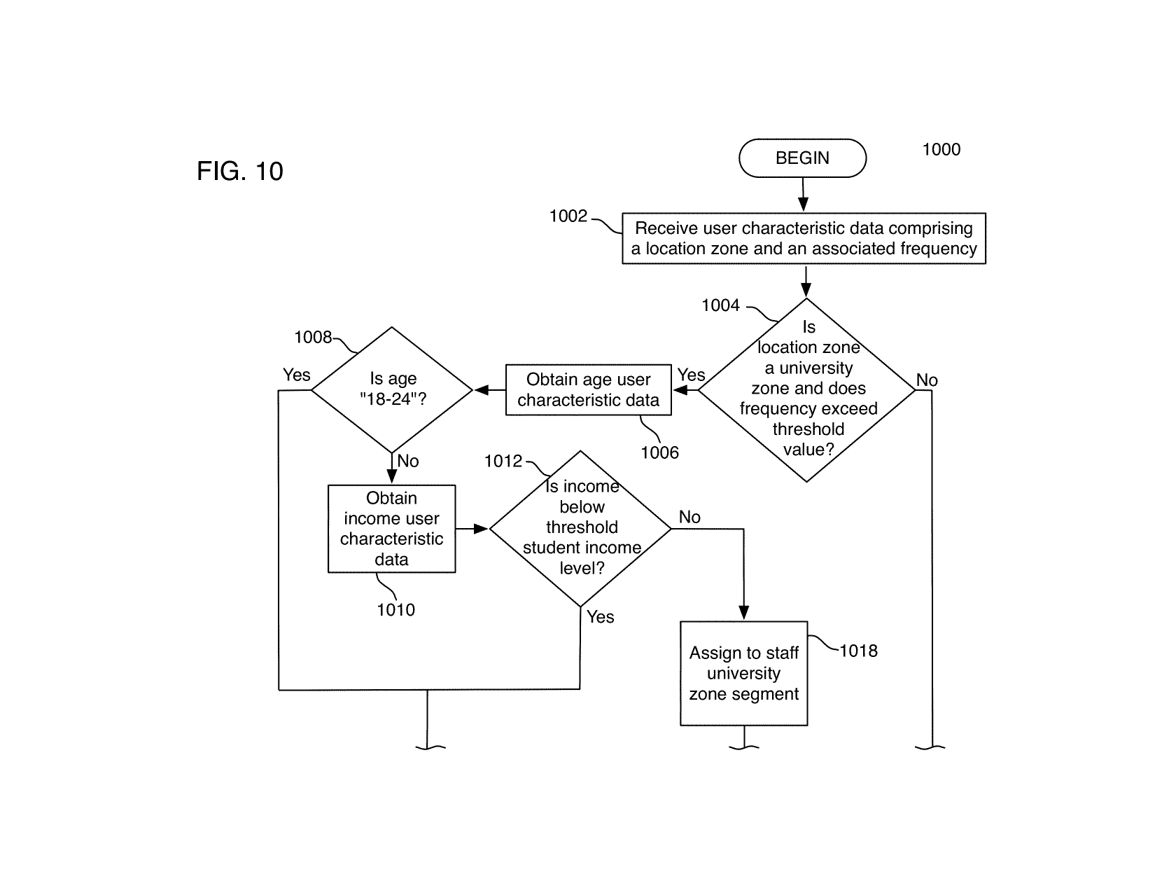

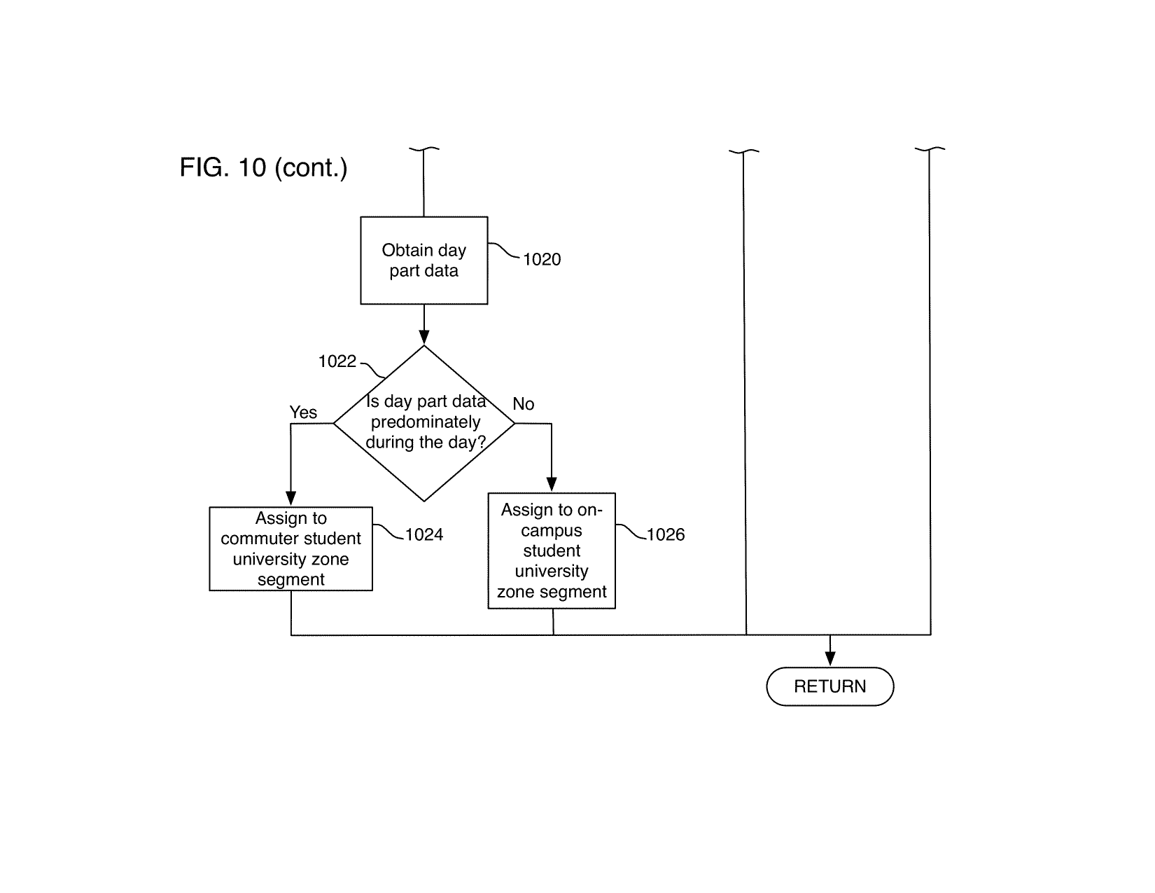

FIG. 10 is a flowchart illustrating steps in a second exemplary method 1000 for assigning a user to a university zone segment. For the sake of clarity, this method is discussed in terms of an exemplary system such as is shown in FIG. 1. Although specific steps are shown in FIG. 10, in other embodiments a method can have more or less steps than show.

The content delivery system 106 can receive user characteristic data associated with a user (1002). The user characteristic data can include at least one location zone and associated frequency information. At some point after receiving the user characteristic data, the content delivery system 106 can check if the received location zone is a university zone and if the frequency associated with the university zone exceeds a predefined threshold value (1004). If the location zone is not a university zone or the frequency associated with the university zone does not exceed the threshold, the content delivery system 106 does not assign the user to a university zone segment and the content delivery system 106 can resume previous processing.

If the location zone is a university zone and the associated frequency exceeds the threshold, the content delivery system 106 can obtain the age user characteristic value for the user (1006). In some cases, the age user characteristic data can be stored in the user's profile, such as in user profile database 156. Additionally, the age user characteristic value can be included in the received user characteristic data. After obtaining the age value, the content delivery system 106 can check if the age value is “18-24” (1008). If so, the content delivery system 106 can obtain the day part data (1020).

If the age value is not “18-24”, the content delivery system 106 can obtain the income user characteristic data (1010). After obtaining the income value, the content delivery system 106 can check if the income is below the threshold student income level (1012). If it is not, the content delivery system 106 can assign the user to the staff university zone segment (1018).

If the income is below the threshold, the content delivery system 106 can also obtain the day part data (1020). Once obtain the day part data associated with the location zone, either after determining that the age value is “18-24” or that the income value is below the student threshold value, the content delivery system 106 can determine whether the day part data is predominately during the day (1022). If so, the content delivery system 106 can assign the user to the commuter student university zone segment (1024). Otherwise, the content delivery system 106 can assign the user to the on-campus student university zone segment (1026). After assigning the user to a university zone segment, the content delivery system 106 resumes previous processing, which can include repeating method 1000.

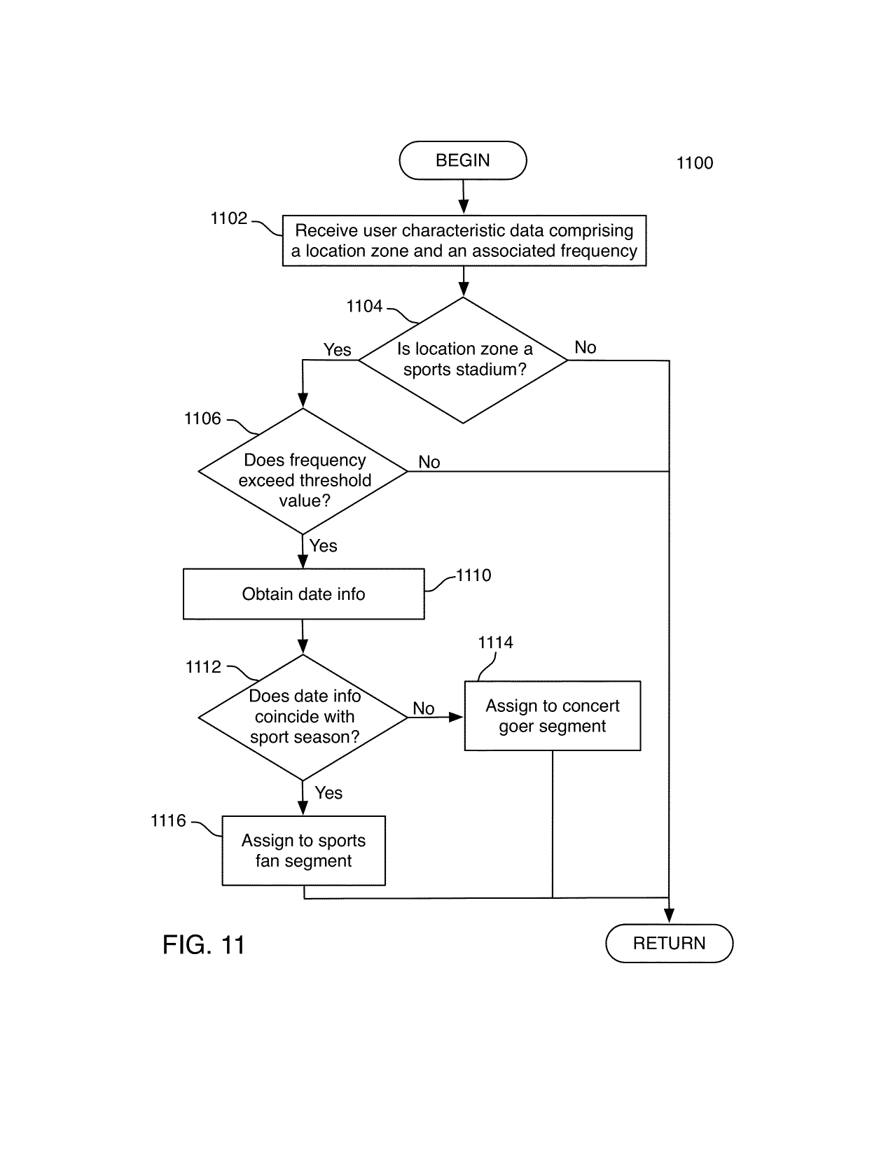

FIG. 11 is a flowchart illustrating steps in an exemplary method 1100 for assigning a user to an entertainment zone segment. For the sake of clarity, this method is discussed in terms of an exemplary system such as is shown in FIG. 1. Although specific steps are shown in FIG. 11, in other embodiments a method can have more or less steps than show.

The content delivery system 106 can receive user characteristic data associated with a user (1102). The user characteristic data can include at least one location zone and associated frequency information. The frequency information can indicate the number of times that the user visited the location zone. At some point after receiving the user characteristic data, the content delivery system 106 can check if the received location zone is a sports stadium zone (1104). If the location zone is not a sports stadium zone, the content delivery system 106 does not assign the user to an entertainment zone segment and the content delivery system 106 can resume previous processing.

If the location zone is a sports stadium zone, the content delivery system 106 can check if the frequency associated with the location zone exceeds a threshold value (1106). In some cases, the received frequency data can be combined with frequency data for the location zone in the user profile. For example, the user may have previously visited the location zone and sent the frequency data to the content delivery system 106. If the frequency value does not exceed the predefined threshold value, the content delivery system 106 does not assign the user to an entertainment zone segment and the content delivery system 106 can resume previous processing.

If the frequency value does exceed the threshold, the content delivery system 106 can obtain the date data associated with the location zone (1110). After obtaining the date data, the content delivery system 106 can check if the date data coincides with a sport season (1112). If so, the content delivery system 106 can assign the user to the sports fan entertainment zone segment (1116). Otherwise, the content delivery system 106 can assign the user to the concert-goer entertainment zone segment (1114). After assigning the user to an entertainment zone segment, the content delivery system 106 resumes previous processing, which can include repeating method 1100.

Methods 700-1100 illustrate five particular methods of assigning a user to a location zone segment. Additional methods are also possible. For example, frequency in a transportation zone can be used to assign a user to a transportation zone segment. In another example, high frequency in a travel zone combined with age can be used to assign a user to a retiree or business traveller transportation zone segment. In yet another example, frequency in a restaurant zone can be used to assign a user to foodie or casual dinner restaurant zone segment. In a further example, frequency in a colloquial zone can be used to assign a user to a visitor or a resident colloquial zone segment. Furthermore, use of additional user characteristic values to assign the user to a targeted segment is not limited to demographic user characteristics. Additional characteristics are also possible, such as behavioral characteristics, spatial-temporal characteristics, etc. While methods 700-1100 illustrate using a single location zone to assign a user to a location zone segment, it is also possible to assign a user to a location segment using multiple location zones. Furthermore, a location zone and associated frequency, date, and/or day part data can be used to assign a user to other types of targeted segments.

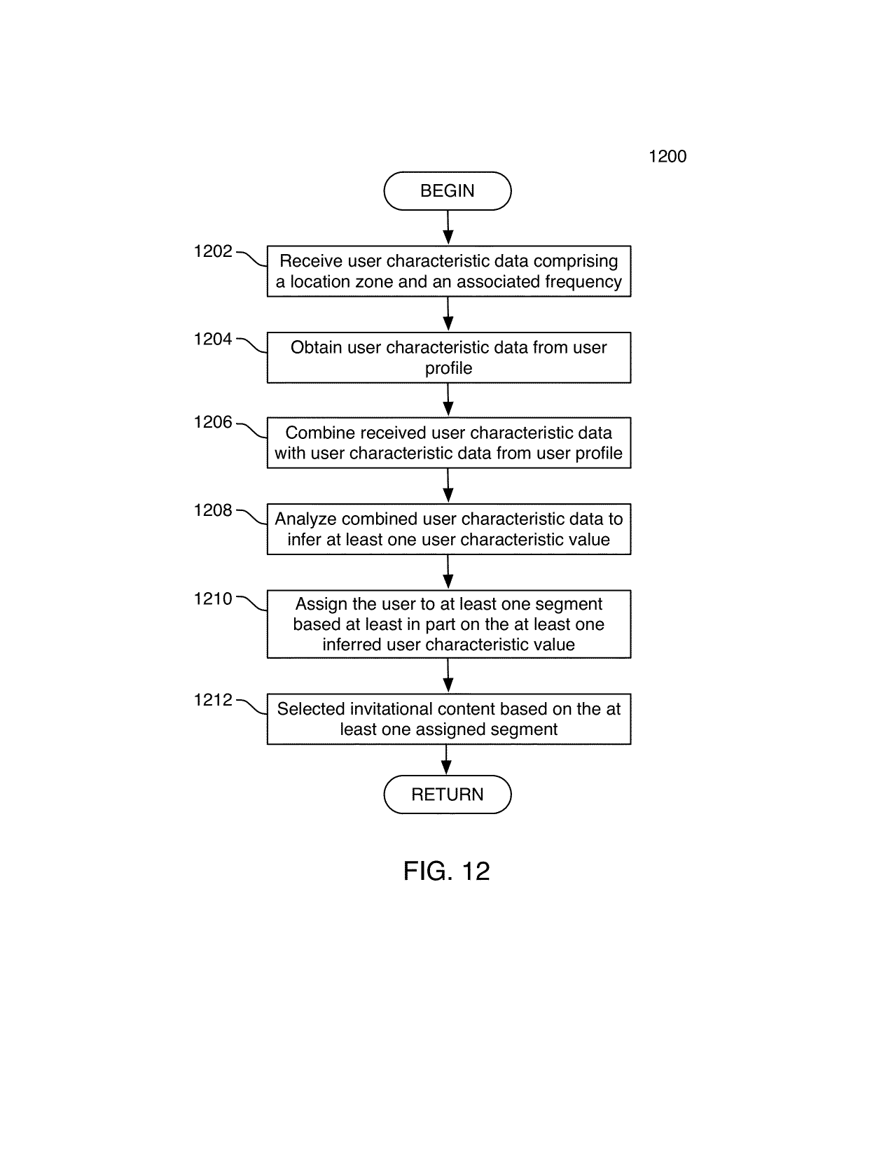

In some embodiments, the content delivery system 106 can be configured to derive unknown user characteristics and then assign a user to a targeted segment based at least in part on the inferred user characteristics. FIG. 12 is a flowchart illustrating steps in an exemplary method 1200 for inferring unknown user characteristics associated with a user based on at least one location zone and associated frequency data and then assigning the user to a segment. For the sake of clarity, this method is discussed in terms of an exemplary system such as is shown in FIG. 1. Although specific steps are show in FIG. 12, in other embodiments a method can have more or less steps than shown.

The content delivery system 106 can receive user characteristic data associated with a user (1202). The user characteristic data can include at least one location zone and associated frequency information. Additionally, in some cases, the user characteristic data can include date and/or day part information. In some embodiments, the content delivery system 106 can receive the location zone, associated frequency information, and any date and/or day part information from a user terminal 102. Alternatively, the content delivery system 106 can receive a location from a user terminal 102 and the content delivery system 106 can communicate with the location analysis system 108 to identify a location zone. The content delivery system 106 can receive the location information in conjunction with a request for targeted content and/or through other interaction with the user terminal 102.

After receiving the user characteristic data, the content delivery system 106 can obtain user characteristic data from the user's profile (1204). For example, the content delivery system 106 can obtain the data from the user profile database 156. The user profile user characteristic data can include a variety of declared and/or inferred user characteristic values. In some cases, the user profile user characteristic data can include location zone data, including frequency, date, and/or day part data. The content delivery system 106 can combine the received user characteristic data with the user profile user characteristic data (1206). In some cases, after combining the data, the content delivery system 106 can update the user profile by storing the combined data in the user profile database 156.

Once the user characteristic data is combined, the content delivery system 106 can analyze the combined user characteristic data to infer or derive one or more user characteristic values (1208). The inference can be based on any number and/or type of user characteristic values. In some cases, the content delivery system 106 can infer an unknown user characteristic value, such as an unknown demographic value like age or occupation. Alternatively, the content delivery system 106 can update the value of a previously inferred/derived user characteristic value. Additionally, the inference can be based at least in part on the received location zone and the frequency, date, and/or day part data associated with the location zone. The inferred user characteristic value can be stored in the user profile.

In some cases, a location zone can have an associated usefulness score to represent the importance of the zone within the system. The usefulness score can be used in inferring user characteristic values when a location zone is used as part of the inference technique. For example, the content delivery system 106 can be configured to only use data associated with a location zone that has a usefulness score above a predefined threshold value. Additionally, the content delivery system 106 can assign a confidence score to the derived value. In some cases, the confidence score can be based at least in part on the usefulness score associated with a location zone used to infer the user characteristic value.

After inferring at least one user characteristic value, the content delivery system 106 can assign the user to at least one segment based on the inferred user characteristic value (1210). In some cases, the inferred user characteristic value can be the sole user characteristic used in the segment assignment. However, in some cases, the inferred value can be combined with other user characteristic values to assign the user to a targeted segment, such as a location zone, a declared user characteristic, and/or another inferred user characteristic value. Additionally, as part of the segment assignment method, the content delivery system 106 can assign a confidence score to the assigned segment, where the confidence score represents the likelihood that the assigned segment is valid and/or correct. In some cases, the confidence score can be based on any confidence score assigned to the inferred user characteristic value. The assigned segment can be store in the user profile, such as in user profile database 156.

At some point, the content delivery system 106 can select invitational content to send to the user terminal 102 based on the segment assignment (1212). In some cases, the selection can be in response to a request for invitational content. Alternatively, the selection can be in response to a request to update the user profile. In this case, the selected invitational content can be stored in the user profile or in some other storage location for later delivery. After selecting the invitational content, the content delivery system 106 resumes previous processing, which can include repeating method 1200.

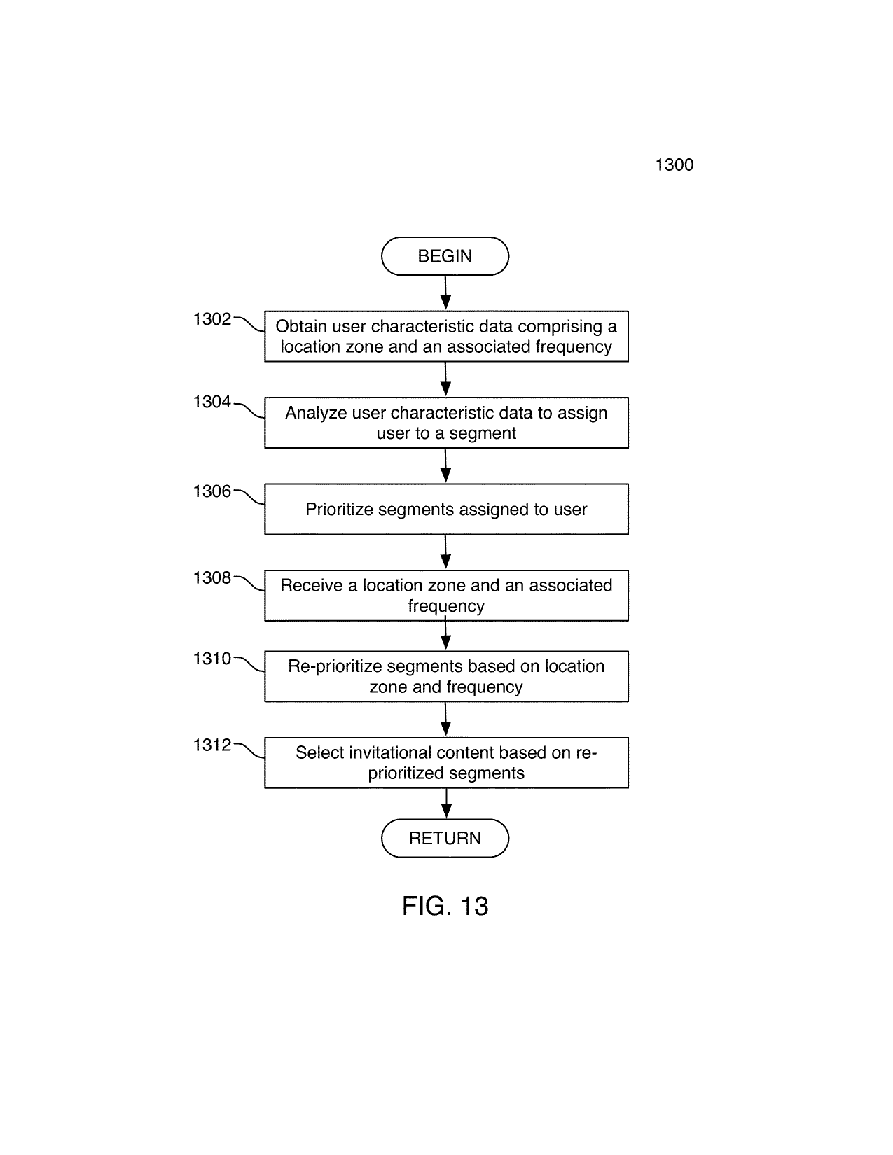

In some embodiments, the content delivery system 106 can be configured to prioritize segments assigned to a user based on a location zone and the associated frequency. FIG. 13 is a flowchart illustrating steps in an exemplary method 1300 for prioritizing segments assigned to a user. For the sake of clarity, this method is discussed in terms of an exemplary system such as is shown in FIG. 1. Although specific steps are show in FIG. 13, in other embodiments a method can have more or less steps than shown.

The content delivery system 106 can obtain user characteristic data (1302). In some cases the user characteristic data can be obtained from the user's profile. For example, the content delivery system 106 can obtain the user characteristic data from the user profile database 156. Alternatively, the content delivery system 106 can obtain the user characteristic data from a user terminal 102. The user characteristic data can include a variety of user characteristic values including at least one location zone and associated frequency information. The frequency information can indicate the number of times that the user visited the location zone. Additionally, in some cases, the user characteristic data can include date and/or day part information.

After obtaining the user characteristic data, the content delivery system 106 can analyze the combined user characteristic data to assign the user to at least one targeted segment (1304). The assignment can be based on any number and/or type of user characteristic values. Furthermore, the user characteristic values can be declared and/or derived/inferred. The content delivery system 106 can be configured to support a variety of targeted segment types. For example, a targeted segment can be a demographic segment, a location zone segment, a spatial-temporal segment, a behavioral segment, etc. The assigned segment can be stored in the user's profile, such as in user profile database 156.

Additionally, as part of the segment assignment method, the content delivery system 106 can assign a confidence score to the assigned segment, where the confidence score represents the likelihood that the assigned segment is valid and/or correct. The calculation of the confidence score can depend on the user characteristic values used to assign the user to the targeted segment. In some cases, the confidence score can be based at least in part on the usefulness score associated with a location zone used to assign the user to the targeted segment.

At some point, the content delivery system 106 can prioritize the segments assigned to the user (1306). The prioritization can be based on a number of factors, such as the user's context, a content provider's campaign goals, the content that is currently available for display to the user, and/or the assigned confidence score. The content delivery system 106 can perform the prioritization in response to an explicit request. Alternatively, the request to prioritize the assigned segments can be implicit. For example, the content delivery system 106 can prioritize the segments in response to a request for invitational content.

After prioritizing the assigned segments, the content delivery system 106 can receive a location zone and an associated frequency (1308). In some embodiments, the content delivery system 106 can receive the location zone and associated frequency information from a user terminal 102. Alternatively, the content delivery system 106 can receive a location from a user terminal 102 and the content delivery system 106 can communicate with the location analysis system 108 to identify a location zone. The content delivery system 106 can receive the location information in conjunction with a request for targeted content and/or through other interaction with the user terminal 102.

In response to receiving the location zone and associated frequency, the content delivery system 106 can re-prioritize the segments (1310). The re-prioritization can be based on the received location zone and associated frequency. In some cases, the re-prioritization can assign a higher ranking to a location zone segment than other segment types. For example, a location zone segment based on the received location zone can be assigned a higher ranking when the frequency associated with the location zone is below a specified threshold. Such a re-prioritization can be based on a principle that a user should be encouraged to visit the location zone. In another example, a location zone segment based on the received location zone can be assigned a higher ranking with the location zone is determined to be an infrequently visited location zone. Such a re-prioritization can be based on a principle that location zones that are visited less frequently are more valuable when a user actually visits them. The method used to determine that a location zone is an infrequently visited location zone can vary with the configuration of the system, e.g. explicitly designated infrequently visited or based on an analysis of the associated frequencies across all users of the system. Additionally, the content delivery system 106 can be configured to charge a higher price for invitational content served in response to a location zone segment based on an infrequently visited location zone.

The re-prioritization can also be based on the usefulness score associated with the received location zone. For example, a location zone segment based on the received location zone can be assigned a lower ranking if the usefulness score is below a specified threshold. Alternatively, the ranking of location zone segments can be based on the assigned usefulness score. Additional methods of re-prioritizing the assigned segments are also possible, such as de-prioritizing when the user's location zone indicates the user may be less receptive to certain types of content. For example, if the location zone corresponds to a work location zone.

At some point, the content delivery system 106 can select invitational content to send to the user terminal 102 based on the re-prioritized segment assignments (1312). In some cases, the selection can be in response to a request for invitational content. Alternatively, the selection can be in response to a request to update the user profile. In this case, the selected invitational content can be stored in the user profile or in some other storage location for later delivery. After selecting the invitational content, the content delivery system 106 resumes previous processing, which can include repeating method 1300.

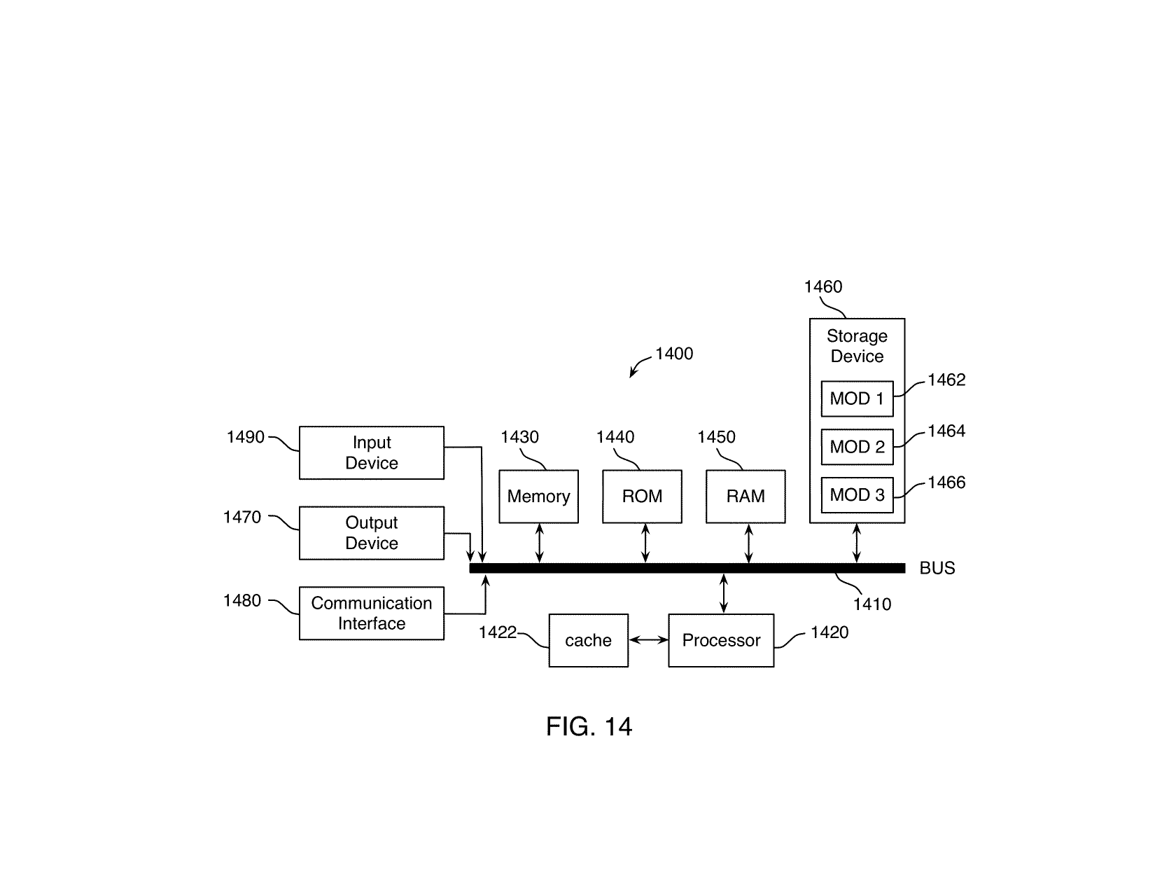

With reference to FIG. 14, an exemplary system 1400 includes a general-purpose computing device 1400, including a processing unit (CPU or processor) 1420 and a system bus 1410 that couples various system components including the system memory 1430 such as read only memory (ROM) 1440 and random access memory (RAM) 1450 to the processor 1420. The system 1400 can include a cache 1422 connected directly with, in close proximity to, or integrated as part of the processor 1420. The system 1400 copies data from the memory 1430 and/or the storage device 1460 to the cache for quick access by the processor 1420. In this way, the cache provides a performance boost that avoids processor 1420 delays while waiting for data. These and other modules can control or be configured to control the processor 1420 to perform various actions. Other system memory 1430 may be available for use as well. The memory 1430 can include multiple different types of memory with different performance characteristics. It can be appreciated that the disclosure may operate on a computing device 1400 with more than one processor 1420 or on a group or cluster of computing devices networked together to provide greater processing capability. The processor 1420 can include any general purpose processor and a hardware module or software module, such as module 1 1462, module 2 1464, and module 3 1466 stored in storage device 1460, configured to control the processor 1420 as well as a special-purpose processor where software instructions are incorporated into the actual processor design. The processor 1420 may essentially be a completely self-contained computing system, containing multiple cores or processors, a bus, memory controller, cache, etc. A multi-core processor may be symmetric or asymmetric.

The system bus 1410 may be any of several types of bus structures including a memory bus or memory controller, a peripheral bus, and a local bus using any of a variety of bus architectures. A basic input/output (BIOS) stored in ROM 1440 or the like, may provide the basic routine that helps to transfer information between elements within the computing device 1400, such as during start-up. The computing device 1400 further includes storage devices 1460 such as a hard disk drive, a magnetic disk drive, an optical disk drive, tape drive or the like. The storage device 1460 can include software modules 1462, 1464, 1466 for controlling the processor 1420. Other hardware or software modules are contemplated. The storage device 1460 is connected to the system bus 1410 by a drive interface. The drives and the associated computer readable storage media provide nonvolatile storage of computer readable instructions, data structures, program modules and other data for the computing device 1400. In one aspect, a hardware module that performs a particular function includes the software component stored in a non-transitory computer-readable medium in connection with the necessary hardware components, such as the processor 1420, bus 1410, output device 1470, and so forth, to carry out the function. The basic components are known to those of skill in the art and appropriate variations are contemplated depending on the type of device, such as whether the device 1400 is a small, handheld computing device, a desktop computer, or a computer server.

Although the exemplary embodiment described herein employs the hard disk 1460, it should be appreciated by those skilled in the art that other types of computer readable media which can store data that are accessible by a computer, such as magnetic cassettes, flash memory cards, digital versatile disks, cartridges, random access memories (RAMs) 1450, read only memory (ROM) 1440, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 1400, an input device 1490 represents any number of input mechanisms, such as a microphone for speech, a touch-sensitive screen for gesture or graphical input, keyboard, mouse, motion input, speech and so forth. An output device 1470 can also be one or more of a number of output mechanisms known to those of skill in the art. In some instances, multimodal systems enable a user to provide multiple types of input to communicate with the computing device 1400. The communications interface 1480 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 1420. The functions these blocks represent may be provided through the use of either shared or dedicated hardware, including, but not limited to, hardware capable of executing software and hardware, such as a processor 1420, that is purpose-built to operate as an equivalent to software executing on a general purpose processor. For example the functions of one or more processors presented in FIG. 14 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 1440 for storing software performing the operations discussed below, and random access memory (RAM) 1450 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 1400 shown in FIG. 14 can practice all or part of the recited methods, can be a part of the recited systems, and/or can operate according to instructions in the recited non-transitory computer-readable storage media. Such logical operations can be implemented as modules configured to control the processor 1420 to perform particular functions according to the programming of the module. For example, FIG. 14 illustrates three modules Mod1 1462, Mod2 1464 and Mod3 1466 which are modules configured to control the processor 1420. These modules may be stored on the storage device 1460 and loaded into RAM 1450 or memory 1430 at runtime or may be stored as would be known in the art in other computer-readable memory locations.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A computer implemented method comprising:
receiving user characteristic data associated with an identified user, the user characteristic data comprising a location zone and an associated frequency;
combining the received user characteristic data with user characteristic data in the identified user's profile to infer at least one characteristic value for the user identifier; and
selecting, via a processor, invitational content based on the at least one inferred characteristic value.

2. The method of claim 1, wherein the location zone comprises at least one of education, transportation, medical, commercial, residential, entertainment, or recreation.

3. The method of claim 1, wherein the at least one inferred characteristic value is a demographic value.

4. The method of claim 3, wherein the demographic value is at least one of age, income, or occupation.

5. The method of claim 1, wherein the user characteristic data further comprises at least one of a date or day part.

6. The method of claim 1, wherein the location zone is assigned a usefulness score.

7. The method of claim 1, wherein the location zone is a university zone and combining further comprises analyzing the associated frequency and at least one demographic user characteristic value to infer an unknown demographic user characteristic value.

8. The method of claim 7, wherein the at least one demographic user characteristic value is an income value and the unknown demographic user characteristic value is an age value.

9. The method of claim 7, wherein the at least one demographic user characteristic value comprises an income value and an age value, and further wherein the unknown demographic user characteristic value is a university status value.

10. The method of claim 1, wherein the location zone is a colloquial zone and combining further comprises analyzing the associated frequency to infer a home region user characteristic value.

11. The method of claim 1, wherein the location zone is a transportation zone and combining further comprises analyzing the associated frequency to infer a travel user characteristic value.

12. The method of claim 1, wherein the location zone is a medical zone and combining further comprises analyzing the associated frequency, an age user characteristic value, and an income user characteristic value to infer a medical professional status user characteristic value.

13. A non-transitory computer-readable storage media storing instructions which, when executed by a computing device, causes the computing device to perform steps comprising:
receiving user characteristic data associated with a user, the user characteristic data comprising location information;
identifying at least one location zone based on the location information;
deriving at least one user characteristic value based on an analysis of the at least one location zone in conjunction with user characteristic data in a user profile associated with the user;
assigning the user to at least one segment based on the at least one derived user characteristic value;
purging the received location information; and
serving invitational content based on the at least one assigned segment.

14. The non-transitory computer-readable storage media of claim 13, wherein the location information comprises a location.

15. The non-transitory computer-readable storage media of claim 13, wherein the location information further comprises at least one of a date or day part.

16. The non-transitory computer-readable storage media of claim 14, wherein the location is expressed as at least one of latitude, longitude, or GPS coordinates.

17. The non-transitory computer-readable storage media of claim 13 further comprising prioritizing segments assigned to the user after assigning the user to at least one segment.

18. The non-transitory computer-readable storage media of claim 17, wherein the prioritizing is based on the location zone.

19. The non-transitory computer-readable storage media of claim 18, wherein the prioritizing is further based on a frequency associated with the location zone.

20. The non-transitory computer-readable storage media of claim 13, wherein the at least one location zone is a university zone and deriving further comprises analyzing a frequency associated with the location zone, an income user characteristic value, and an age user characteristic value to infer a university status user characteristic value.

21. The non-transitory computer-readable storage media of claim 13, wherein the at least one location zone is a university zone and deriving further comprises analyzing a frequency associated with the location zone and an income user characteristic value to infer an age user characteristic value.

22. The non-transitory computer-readable storage media of claim 13, wherein the at least one location zone is a university zone and deriving further comprises analyzing a frequency associated with the location zone, a user characteristic age value, a user characteristic income value, and day part information associated with the location zone to infer a user characteristic university status value.

23. A system comprising:
a server;
a first module configured to control the server to receive user characteristic data associated with a user, the user characteristic data comprising a location zone and an associated frequency;
a second module configured to control the server to integrate the received user characteristic data with user characteristic data from a user profile for the user;
a third module configured to control the server to analyze the integrated user characteristic data to assign the user to a segment, the segment comprising at least one of a demographic segment or a location zone segment; and
a fourth module configured to control the server select invitational content.

24. The system of claim 23, wherein assigning further comprises:
a fifth module configured to control the server to derive at least one user characteristic value for the user; and
a sixth module configured to control the server to assign the user to the segment based on the at least one derived user characteristic value.

25. The system of claim 23, wherein the selecting further comprises:
a fifth module configured to control the server to prioritize segments assigned to the user, wherein the segments comprise at least one of a demographic segment and a location zone segment, and further wherein the prioritizing is based on the received location zone and associated frequency; and
a sixth module configured to control the server to select invitational content based on the prioritized segments.

26. The system of claim 23, wherein the associated frequency comprises a plurality of frequency counts, each frequency count associated with a category.

27. The system of claim 26, wherein the category is based on duration of a visit to the location zone.

28. A computer implemented method comprising:
receiving a location associated with an identified user;
obtaining a location zone profile for the identified user, the location zone profile comprising at least one location zone and an associated frequency;
identifying, via a processor, a predefined location zone based on the received location;
updating the user's location zone profile based on the identified predefined location, the updating comprising incrementing a frequency count associated with an entry in the location zone profile for the predefined location;
purging the received location; and
sending user characteristic data, the user characteristic data comprising a location zone and an associated frequency.

29. The method of claim 28 further comprising:
receiving at least one of a date or day part associated with the location; and
updating the entry in the location zone profile for the predefined location zone to reflect the at least one of the date or day part.

30. The method of claim 28, wherein the user characteristic data is sent in conjunction with a request for invitational content.

31. A computer implemented method comprising:
obtain user characteristic data, the user characteristic data comprising at least one location zone with an associated frequency;
analyze the user characteristic data to assign the user to a segment;
prioritize segments assigned to the user, wherein the segments comprise at least one of a demographic segment and a location zone segment;
receive a location zone and associated frequency;
reprioritize segments based on the received location zone and associated frequency; and
serve invitational content based on the reprioritized segments.

32. The method of claim 31, wherein the segments are reprioritized to assign a higher ranking to a location zone segment based on the location zone when the frequency associated with the location zone is below a predetermined threshold.

33. The method of claim 31, wherein the segments are reprioritized to assign a higher ranking to a location zone segment based on the location zone when the location zone is an infrequently visited location zone.

34. The method of claim 33, wherein the cost charged to an invitational content provider is greater for invitational content served in response to a location zone segment based on an infrequently visited location zone.

35. The method of claim 31, wherein a usefulness score is associated with the location zone and the segments are reprioritized based at least in part on the usefulness score.
